(19) United States
(12) Patent Application Publication
(10) Pub. No.: US 2011/0131038 A1
(43) Pub. Date: Jun. 2, 2011

(54) EXCEPTION DICTIONARY CREATING UNIT, EXCEPTION DICTIONARY CREATING METHOD, AND PROGRAM THEREFOR, AS WELL AS SPEECH RECOGNITION UNIT AND SPEECH RECOGNITION METHOD

(76) Inventors: Satoshi Oyaizu, Tokyo (JP); Masashi Yamada, Tokyo (JP)

(21) Appl. No.: 13/057,373

(22) PCT Filed: Aug. 7, 2009
(86) PCT No.: PCT/JP2009/064045

§ 371 Date: Feb. 3, 2011

(30) Foreign Application Priority Data
Aug. 11, 2008 (JP) 2008-207406

(51) Int. Cl. G06F 17/21

(52) U.S. Cl. 704/10

(57) ABSTRACT

An exception dictionary creating device, an exception dictionary creating method, and a program therefor allowing creating an exception dictionary are provided for affording high speech recognition performance while reducing the size of the exception dictionary, as well as a speech recognition device and a speech recognition method capable of recognizing a speech with high accuracy of recognition by using the exception dictionary. To achieve this, a text-to-phonetic symbol converting unit (21) of an exception dictionary creating device (10) creates converted phonetic symbol sequence by converting text sequence of vocabulary list data (21) into phonetic symbol sequence. A recognition degradation contribution degree calculating unit (24) calculates a recognition degradation contribution degree when the converted phonetic symbol sequence is not identical to a correct phonetic symbol sequence registered in a database or word dictionary (50). An exception dictionary registering unit (41) registers in the exception dictionary (60) the text sequence and the phonetic symbol sequence registered in the text sequence of the vocabulary list data (12) with a high degree of recognition degradation contribution degree to the recognition so as not to exceed data limitation capacity indicated by exception dictionary memory size content (71).

### FIELD OF THE INVENTION

The present invention relates to an exception dictionary creating device, an exception dictionary creating method and a program therefor creating an exception dictionary used for a converter which converts text sequence of vocabulary into phonetic symbol sequences, as well as a speech recognition device and a speech recognition method for carrying out speech recognition using the exception dictionary.

### RELATED ART

In the speech synthesis device which converts any vocabulary and sentences expressed in text form into a speech and outputs the speech, and in the speech recognition device which carries out speech recognition of the vocabulary and the sentences registered in a speech recognition dictionary based on their textual representation, a text-to-phonetic symbol converting device has been used for converting an input text into phonetic symbol sequence. Processing to convert the vocabulary in textual representation into the phonetic symbol sequence executed by the device is also called as a text-to-phoneme conversion or a grapheme-to-phoneme conversion. One example of a speech recognition device where the textual representation of vocabulary to be recognized is previously registered in a speech recognition dictionary for speech recognition includes a cellular phone which performs speech recognition of a name of a called party registered in a telephone directory of the cellular phone and makes a telephone call to a telephone number corresponding to the registered name. The example also includes a hands-free communication device, used in combination with the cellular phone, reads the telephone directory of the cellular phone to perform voice dialing. When the name of the called party registered in the telephone directory stored in the cellular phone is input only along with textual representation without phonetic symbol sequence, registration of the registered name in the speech recognition dictionary is not possible. This is because it needs to provide phonetic symbol sequence such as phoneme representation indicative of readings of the registered name as information to be registered in the speech recognition dictionary. For this reason, the text-to-phonetic symbol converting device has been used in order to convert the textual representation of the registered name of the called party into the phonetic symbol sequence. As shown in FIG. 25, the name is registered as the vocabulary to be recognized in the speech recognition dictionary based on the phonetic symbol sequence obtained by the text-to-phonetic symbol converting device. Thus, the speech recognition of the registered name uttered by a user of the cellular phone allows the user to make a telephone call to the telephone number corresponding to the registered name without any complicated button operations (see FIG. 26).

Another example of a speech recognition device where textual representation of a word to be recognized is previously registered in a speech recognition dictionary for speech recognition includes an in-vehicle audio device which is capable of connecting a portable digital music player which plays music files stored in a built-in hard disk or in a built-in semiconductor memory. The in-vehicle audio device is equipped with a speech recognition function which takes a song title and an artist's name related with the music files stored in the connected portable digital music player as vocabulary to be recognized for speech recognition. In the same way as the above-mentioned hands-free communication device, because the song title and the artist's name related with the music files stored in the portable digital music player are inputted only together with textual representation without the phonetic symbol sequence, it requires to provide the text-to-phonetic symbol converting device (see FIG. 27 and FIG. 28).

One example of a method adopted in the traditional text-to-phonetic symbol converting unit includes a word dictionary-based method and a rule-based method. Among these, the word dictionary-based method organizes a words dictionary in which each of text sequence such as a word etc., is related with phonetic symbol sequence. In processing of the text-to-phonetic symbol converting device of the speech recognition device, a search is made into the word dictionary for input text sequence of a word etc. that is vocabulary to be recognized to output phonetic symbol sequence corresponding to the input text sequence. It; however, requires that the method should have a large-sized word dictionary for the purposes of widely covering input text sequence that may be input at any chance, resulting in a problem of increased memory requirement for developing the word dictionary.

One example of a method for use in the text-to-phonetic symbol converting device to solve the aforesaid problem of the memory requirement includes a rule-based method. For example, when “IF (condition) then (phonetic symbol sequence)” is utilized as a rule concerning the text sequence, the rule is applied to cases where a part of the text sequence meets the condition. Such cases include where conversion is carried out in conformity only to the rule by completely substituting the contents of the word dictionary with the rule, and where conversion is carried out in combination with the word dictionary and the rule. A unit aiming at reducing the size of a word dictionary for a speech synthesis system using a text-to-phonetic symbol converting unit in situation where the word dictionary and a rule are used in combination with each other has been disclosed e.g., in Patent Document 1.

FIG. 29 is a block diagram showing processing of the word dictionary size reducing unit disclosed in Patent Document 1. The word dictionary size reducing unit deletes words registered in the word dictionary by going through processing consisting of two phases, thereby reducing the size of the word dictionary. In phase 1, a word with correct phonetic symbol sequence is created using the rule is taken as a candidate to be deleted from the word dictionary out of words registered in the original word dictionary. As an example of a rule, illustrated is one composed of a rule for prefix, a rule for an infix, and a rule for a suffix.

Next, in phase 2, when a word registered in the word dictionary is available as a root word of another word, the word is left in the word dictionary as the root word. Doing in this way excludes the word from candidates to be deleted even though the word is listed as a candidate to be deleted in the phase 1. On the other hand, when a word with correct phonetic symbol sequence is created using one or more root words and rules, the word is to be deleted from the word dictionary, instead of a word which is not a candidate to be left in the word dictionary as the root word among words consisting of a large number of characters.

Deletion of the word ultimately determined to be a candidate from the word dictionary crates a downsized word dictionary after termination of the phase 1 and the phase 2. The word dictionary created in this way is sometimes called as an “exception dictionary” because it is a dictionary devoted to exception words unable to derive the phonetic symbol sequence from the rule.

### PRIOR ART DOCUMENT

Patent Document 1: U.S. Pat. No. 6,347,298

### SUMMARY OF INVENTION

### Problem to be Solved

Patent Document 1 naturally fails to disclose reducing the size of the words dictionary in consideration of speech recognition performance, as it is a words dictionary for the speech synthesis system. Further, although Patent Document 1 discloses a method of reducing the size of the dictionary in a course of creating the exception dictionary, it does not disclose how to create an exception dictionary taking account of the speech recognition performance within this limit where a memory capacity limitation is put thereon.

In Patent Document 1, it takes measures to register texts and their phonetic symbol sequence conforming to a standard determining whether or not the phonetic symbol sequence created by the rule and those in the words dictionary match each other. The exception dictionary created in this way and the vocabulary to be recognized covered by the rule do not affect the speech recognition performance no matter how they do not match with each other. Alternatively, as shown in FIG. 30A, irrespective of whether the unmatching which exerts a little influence occurs, they are registered in the exception dictionary for a mere reason of the unmatching existing only in a part of the phonetic symbol sequence. This gives rise to a problem that the size of the exception dictionary is wastefully consumed. Moreover, when the size of the exception dictionary created in accordance with the manner of the abovementioned Patent Document 1 exceeds a memory capacity limitation of the device, it induces a problem that selection of a text and the phonetic symbol sequence exerting no bad influence on the speech recognition performance are not able to select, even if they are deleted from the exception dictionary.

The present invention is made in view of such problems and has the object of providing an exception dictionary creating device, an exception dictionary creating method, and a program therefor enabling creating an exception dictionary affording high speech recognition performance while reducing the size of the exception dictionary, as well as a speech recognition device and a speech recognition method recognizing a speech with a high accuracy of recognition using the exception dictionary

### Solution to Problem

To solve the aforesaid problems, the present invention according to claim 1 provides an exception dictionary creating device for creating an exception dictionary used for a converter converting a text sequence of a vocabulary to be recognized into a phonetic symbol sequence on the basis of a rule of converting the text sequence of the vocabulary into the phonetic symbol sequence and the exception dictionary storing the text sequence of an exception word not to be converted by the rule and a correct phonetic symbol sequence of the text sequence in correlation with each other, the exception dictionary creating device comprising: a text-to-phonetic symbol converting unit for converting the text sequence of the vocabulary to be recognized into the phonetic symbol sequence; a recognition degradation contribution degree calculating unit for calculating a recognition degradation contribution degree that is a degree of exerting an influence on degradation of a speech recognition performance due to a difference between a converted phonetic symbol sequence which is a conversion result of the text-to-phonetic symbol converting unit and the correct phonetic symbol sequence of the text sequence of the vocabulary to be recognized, when the converted phonetic symbol sequence is not identical to the correct phonetic symbol sequence; and an exception dictionary registering unit for selecting the vocabulary to be recognized that is a subject to be registered from a plurality of the vocabularies to be recognized on the basis of the recognition degradation contribution degree for each of the plurality of the vocabularies to be recognized by the recognition degradation contribution degree calculating unit, and for registering in the exception dictionary the text sequence of the vocabulary to be recognized that is a selected subject to be registered and the correct phonetic symbol sequence of the text sequence.

According to the present invention, the exception dictionary creating device selects the vocabulary to be recognized that is the subject to be registered from the plurality of vocabulary to be recognized on the basis of the recognition degradation contribution degree for each of the plurality of the respective vocabularies to be recognized, and registers in the exception dictionary the text sequence of the vocabulary to be recognized that is the selected subject to be registered and the correct phonetic symbol sequence. Preferential selection of the vocabulary with a high degree of influence on the degradation of the speech recognition performance to register it in the exception dictionary enables creating the exception dictionary affording the high speech recognition performance while reducing the size of the exception dictionary.

The exception dictionary creating device of claim 2 according to claim 1, further comprising an exception dictionary memory size condition storing unit for storing a limitation of data capacity memorable in the exception dictionary, wherein the exception dictionary registering unit carries out the registration so that a data amount to be registered in the exception dictionary does not exceed the limitation of the data capacity.

According to the present invention, since the registration can be done in the exception dictionary so that the data amount to be registered does not exceed the data limitation capacity registered in the exception dictionary memory size condition storing unit, the invention allows creating the exception dictionary affording high speech recognition performance even when the size of the exception dictionary is under a predetermined limitation.

The exception dictionary creating device of claim 3 according to claim 1 or claim 2, wherein the exception dictionary registering unit selects the vocabulary to be recognized that is the subject to be registered also on the basis of a frequency in use of the plurality of the vocabularies to be recognized.

According to the present invention, since the invention allows further selecting the vocabulary to be registered that is the subject to be registered on the basis of the frequency in use, in addition to the recognition degradation contribution degree, it makes it possible e.g., to select the vocabulary to be recognized with high frequency in use in spite of its small degree of the recognition degradation contribution degree. This creates the exception dictionary offering high speech recognition performance while reducing the size of the exception dictionary.

The exception dictionary creating device of claim 4 according to claim 3, the exception dictionary registering unit preferentially selects the vocabulary to be recognized with the frequency in use greater than a predetermined threshold as the vocabulary to be recognized that is the subject to be registered irrespective of the recognition degradation contribution degree.

According to the present invention, since the exception dictionary registering unit permits preferentially selecting the vocabulary to the recognized with high frequency in use greater than predetermined frequency in use, regardless of the recognition degradation contribution degree, it enables registering in the exception dictionary the vocabulary to be recognized with high frequency in use in preference to the another vocabulary. This creates the exception dictionary affording the high speech recognition performance while reducing the size of the exception dictionary.

The exception dictionary creating device of claim 5 according to any one of claim 1 to claim 4, wherein the recognition degradation contribution degree calculating unit calculates a spectral distance measure between the converted phonetic symbol sequence and the correct phonetic symbol sequence as the recognition degradation contribution degree.

The exception dictionary creating device of claim 6 according to any one of claim 1 to claim 4, wherein the recognition degradation contribution degree calculating unit calculates a difference between a speech recognition likelihood that is a recognized result of a speech based on the converted phonetic symbol sequence and a speech recognition likelihood that is a recognized result of the speech based on the correct phonetic symbol sequence as the recognition degradation contribution degree.

The exception dictionary creating device of claim 7 according to any one of claim 1 to claim 4, wherein the recognition degradation contribution degree calculating unit calculates a route distance between the converted phonetic symbol sequence and the correct phonetic symbol sequence by best matching, and calculates a normalized route distance by normalizing the calculated route distance with a length of the correct phonetic symbol sequence, as the recognition degradation contribution degree.

The exception dictionary creating device of claim 8 according to claim 7, wherein the recognition degradation contribution degree calculating unit calculates a similarity distance as the route distance by adding weighting on the basis of a relationship of the corresponding phonetic symbol sequence between the converted phonetic symbol sequence and the correct phonetic symbol sequence, and calculates the normalized similarity distance by normalizing the calculated similarity distance with the length of the correct phonetic symbol sequence, as the recognition degradation contribution degree.

A speech recognition device of claim 9 comprising: a speech recognition dictionary creating unit for converting a text sequence of a vocabulary to be recognized into a phonetic symbol sequence using the exception dictionary created by the exception dictionary creating device according to any one of claim 1 to claim 8, and for creating a speech recognition dictionary based on the converted result; and a speech recognizing unit for performing speech recognition using the speech recognition dictionary created by the speech recognition dictionary creating unit.

According to the present invention, the invention enables achieving high speech recognition performance while utilizing a small sized exception dictionary.

An exception dictionary creating method of claim 10 for creating an exception dictionary used for in a converter converting a text sequence of vocabulary to be recognized into a phonetic symbol sequence on the basis of a rule of converting the text sequence of the vocabulary into the phonetic symbol sequence and the exception dictionary in which the text sequence of an exception words not to be converted by the rule and the correct phonetic symbol sequence of the text sequence is stored in correlation with each other, the exception dictionary creating method comprising: a text-to-phonetic symbol converting step of converting the text sequence of the vocabulary to be recognized into the phonetic symbol sequence; a recognition degradation contribution degree calculating step of calculating a recognition degradation contribution degree that is a degree of exerting an influence on degradation of speech recognition performance due to a difference between a converted phonetic symbol sequence which is a conversion result of the text-to-phonetic symbol converting step and a correct phonetic symbol sequence of the text sequence of the vocabulary to be recognized, when the converted phonetic symbol sequence is not identical to the correct phonetic symbol sequence; and an exception dictionary registering step of selecting the vocabulary to be recognized that is a subject to be registered from the plurality of vocabulary to be recognized on the basis of the recognition degradation contribution degree calculated for each of the plurality vocabulary to be recognized in the recognition degradation contribution degree calculating step, and registering in the exception dictionary the text sequence of the vocabulary to be recognized that is a selected subject to be registered and the correct phonetic symbol sequence of the text sequence.

A speech recognition method of claim 11 comprising: a speech recognition dictionary creating step for converting a text sequence of the vocabulary to be recognized into a phonetic symbol sequence using the exception dictionary created by the exception dictionary creating method according to claim 10, and for creating a speech recognition dictionary based on the converted result; and a speech recognizing step for performing speech recognition using the speech recognition dictionary created by the speech recognition dictionary creating step.

An exception dictionary creating program of claim 12 executed by a computer for creating an exception dictionary used for a converter converting a text sequence of a vocabulary to be recognized into a phonetic symbol sequence on the basis of a rule of converting the text sequence of the vocabulary into the phonetic symbol sequence and the exception dictionary storing the text sequence of an exception word not to be converted by the rule and a correct phonetic symbol sequence of the text sequence in correlation with each other, the exception dictionary creating program comprising: a text-to-phonetic symbol converting unit for converting the text sequence of the vocabulary to be recognized into the phonetic symbol sequence; a recognition degradation contribution degree calculating unit for calculating a recognition degradation contribution degree that is a degree of exerting an influence on degradation of a speech recognition performance due to a difference between a converted phonetic symbol sequence which is a conversion result of the text-to-phonetic symbol converting step and a correct phonetic symbol sequence of the text sequence of the vocabulary to be recognized, when the converted phonetic symbol sequence is not identical to the correct phonetic symbol sequence; and an exception dictionary registering unit for selecting the vocabulary to be recognized that is a subject to be registered from a plurality of the vocabularies to be recognized on the basis of the recognition degradation contribution degree for each of the plurality of the vocabularies to be recognized by the recognition degradation contribution degree calculating unit, and for registering in the exception dictionary the text sequence of the vocabulary to be recognized that is a selected subject to be registered and the correct phonetic symbol sequence of the text sequence.

An exception dictionary creating device of claim 13 for creating an exception dictionary used for a converter converting a text sequence of a vocabulary to be recognized into a phonetic symbol sequence on the basis of a rule of converting the text sequence of the vocabulary into the phonetic symbol sequence and the exception dictionary storing the text sequence of an exception word not to be converted by the rule and a correct phonetic symbol sequence of the text sequence in correlation with each other, the exception dictionary creating device comprising: a text-to-phonetic symbol converting unit for converting the text sequence of the vocabulary to be recognized into the phonetic symbol sequence; an inter-phonetic symbol sequence distance calculating unit for calculating an inter-phonetic distance that is distance between a speech based on a converted phonetic symbol sequence which is a converted result of the text sequence of the vocabulary to be recognized by the text-to-phonetic symbol converting unit and a speech based on the correct phonetic symbol sequence of the text sequence of vocabulary to be recognized, when the converted phonetic symbol sequence is not identical to the correct phonetic symbol sequence; and an exception dictionary registering unit for selecting the vocabulary to be recognized that is a subject to be registered from a plurality of the vocabularies to be recognized on the basis of the inter-phonetic symbol sequence distance for each of the plurality of the vocabularies to be recognized by the inter-phonetic symbol sequence distance calculating unit, and for registering in the exception dictionary the text sequence of the vocabulary to be recognized that is a selected subject to be registered and the correct phonetic symbol sequence of the text sequence.

According to the present since invention, the exception dictionary creating device selects the vocabulary to be recognized that is the subject to be registered from the plurality of vocabulary to be recognized on the basis of the inter-phonetic symbol distance between the phonetic symbol sequence for each of the plurality of respective vocabularies to be recognized, and registers in the exception dictionary the text sequence of the vocabulary to be recognized that is the selected subject to be registered and the correct phonetic symbol sequence. This preferentially selects the vocabulary with a high degree of influence on the degradation of the speech recognition performance to register it in the exception dictionary, thus creating the exception dictionary affording high speech recognition performance while reducing the size of the exception dictionary.

An exception dictionary creating method of claim 14 for creating an exception dictionary use for in a converter converting a text sequence of a vocabulary to be recognized into a phonetic symbol sequence on the basis of a rule of converting the text sequence of the vocabulary into the phonetic symbol sequence and the exception dictionary in which the text sequence of an exception word not to be converted by the rule and a correct phonetic symbol sequence of the text sequence are stored in correlation with each other, the exception dictionary creating method comprising: a text-to-phonetic symbol converting step of converting the text sequence of the vocabulary to be recognized into the phonetic symbol sequence; an inter-phonetic symbol sequence distance calculating step of calculating an inter-phonetic distance that is distance between a speech based on a converted phonetic symbol sequence which is a converted result of the text sequence of the vocabulary to be recognized by the text-to-phonetic symbol converting unit and a speech based on the correct phonetic symbol sequence of the text sequence of vocabulary to be recognized, when the converted phonetic symbol sequence is not identical to the correct phonetic symbol sequence; and an exception dictionary registering step of selecting the vocabulary to be recognized that is a subject to be registered from a plurality of the vocabulary to be recognized on the basis of the inter-phonetic symbol sequence distance calculated for each of the plurality vocabulary to be recognized in the inter-phonetic symbol sequence distance calculating step, and registering in the exception dictionary the text sequence of the vocabulary to be recognized that is a selected subject to be registered and the correct phonetic symbol sequence of the text sequence.

An exception dictionary creating program of claim 15 executed by a computer for creating an exception dictionary used for a converter converting a text sequence of a vocabulary to be recognized into a phonetic symbol sequence on the basis of a rule of converting the text sequence of the vocabulary into the phonetic symbol sequence and the exception dictionary storing the text sequence of an exception word not to be converted by the rule and a correct phonetic symbol sequence of the text sequence in correlation with each other, the exception dictionary creating program comprising: a text-to-phonetic symbol converting unit for converting the text sequence of the vocabulary to be recognized into the phonetic symbol sequence; an inter-phonetic symbol sequence distance calculating unit for calculating an inter-phonetic distance between a speech based on the converted phonetic symbol sequence which is a converted result of the text sequence of the vocabulary to be recognized by the text-to-phonetic symbol converting unit and a speech based on the correct phonetic symbol sequence of the text sequence of vocabulary to be recognized, when the converted phonetic symbol sequence is not identical to the correct phonetic symbol sequence of the text sequence; and an exception dictionary registering unit for selecting the vocabulary to be recognized that is a subject to be registered from a plurality of the vocabularies to be recognized on the basis of the inter-phonetic symbol sequence distance for each of the plurality of the vocabularies to be recognized by the inter-phonetic symbol sequence distance calculating unit, and for registering in the exception dictionary the text sequence of the vocabulary to be recognized that is a selected subject to be registered and the correct phonetic symbol sequence of the text sequence.

A vocabulary-to be recognized registering device of claim 16 comprising: a vocabulary, to be recognized, having a text sequence of the vocabulary and a correct phonetic symbol sequence of the text sequence; a text-to-phonetic symbol converting unit for converting the text sequence of the vocabulary to be recognized into the phonetic symbol sequence by a predetermined rule; a converted phonetic symbol sequence converted by the text-to-phonetic symbol converting unit; an inter-phonetic symbol sequence distance calculating unit for calculating a distance between a speech based on the converted phonetic symbol sequence and a speech based on the correct phonetic symbol sequence; and

a vocabulary to be recognized registering unit for registering the vocabulary to be recognized on the basis of the distance between the phonetic symbol sequence calculated by the inter-phonetic symbol sequence distance calculating unit.

A vocabulary-to be recognized registering device of claim 17 comprising: a text-to-phonetic symbol sequence converting unit for converting a text sequence of a vocabulary to be recognized into a phonetic symbol sequence by_a predetermined rule; an inter-phonetic symbol sequence distance calculating unit for calculating a distance between a speech based on the phonetic symbol sequence converted by the text-to-phonetic symbol converting unit and a speech based on the correct phonetic symbol sequence of the vocabulary to be recognized; and a vocabulary-to be recognized registering unit for registering the vocabulary to be recognized on the basis of the distance between the phonetic symbol sequence calculated by the inter-phonetic symbol sequence distance calculating unit.

A speech recognition device of claim 18 comprising: an exception dictionary containing vocabulary to be recognized registered by the vocabulary-to be recognized registering unit of the vocabulary-to be recognized registering device according to claim 16 or claim 17; a speech recognition dictionary creating unit for converting the text sequence of the vocabulary to be recognized into the phonetic symbol sequence using the exception dictionary, and creating a speech recognition dictionary based on the converted result; and a speech recognition unit for performing speech recognition using the speech recognition dictionary created by the speech recognition dictionary creating unit.

According to the present invention, since the exception dictionary creating device selects the vocabulary to be recognized that is the subject to be registered from the plurality of vocabulary to be recognized on the basis of the recognition degradation contribution degree for each of plurality of vocabulary to be recognized, and registers in the exception dictionary the text sequence of the vocabulary to be recognized that is the selected subject to be registered and the phonetic symbol sequence, the exception dictionary creating device enables preferentially and selectively in the exception dictionary the vocabulary to be registered with high degree of influence on the degradation of the speech recognition performance. This allows creating the exception dictionary affording high speech recognition performance while reducing the size of the exception dictionary.

### BRIEF DESCRIPTION OF THE DRAWINGS

FIG. 1 is a block diagram showing a basic configuration of the exception dictionary creating device according to the present invention;

FIG. 2 is a block diagram showing a configuration of the exception dictionary creating device according to the first embodiment of the present invention;

FIG. 3A is data structure of vocabulary data according to the first embodiment, and FIG. 3B is data structure of vocabulary list data;

FIG. 4 is a block diagram showing a configuration of the speech recognition device according to the first embodiment;

FIG. 5 is a flow chart showing a processing procedure executed by the exception dictionary creating device according to the first embodiment;

FIG. 6 is a flow chart showing a processing procedure executed by the exception dictionary creating device according to the first embodiment;

FIG. 7 is a flow chart showing a processing procedure executed by the exception dictionary creating device according to the first embodiment;

FIG. 8 is a diagram for describing the recognition degradation contribution degree calculating method using a result of LPC cepstrum distance according the first embodiment;

FIG. 9 is a diagram for describing the recognition degradation contribution degree method using a result of speech recognition likelihood according the first embodiment;

FIG. 10 is a diagram showing a specific example of DP matching according to the first embodiment;

FIG. 11 is a diagram for describing the recognition degradation contribution degree method using the result of DP matching according to the first embodiment;

FIG. 12 is a diagram for describing the recognition degradation contribution degree calculating method using results of the DP matching and weighting with the phonetic symbol sequence;

FIG. 13 is a diagram for describing a method for calculating a similarity distance using a substitution table, an insertion distance table, and a deletion table according to the first embodiment;

FIG. 14 is a drawing for describing a method for calculating a similarity distance using a matched distance table according to the first embodiment;

FIG. 15 is a flow chart showing a processing procedure executed by the exception dictionary creating device according to the second embodiment of the present invention;

FIG. 16 is a diagram for describing a procedure for sorting candidate vocabulary data to be registered using the recognition degradation contribution degree and the frequency in use according to the second embodiment;

FIG. 17 is a diagram for describing a procedure for sorting the candidate vocabulary data to be registered using the recognition degradation contribution degree and the frequency in use according to the second embodiment;

FIG. 18 is a diagram for describing a procedure for sorting the candidate vocabulary data to be registered using the recognition degradation contribution degree and the frequency in use according to the second embodiment;

FIG. 19 is a diagram for describing a procedure for sorting the candidate vocabulary data to be registered using the recognition degradation contribution degree and the frequency in use according to the second embodiment;

FIG. 20 a diagram for describing a procedure for sorting the candidate vocabulary data to be registered using a preferential frequency in use condition according to the second embodiment;

FIG. 21 is a block diagram showing a configuration of the exception dictionary creating device according the third embodiment of the present invention;

FIG. 22A is a schematic diagram of data structure of the processed vocabulary list data according the third embodiment, FIG. 22B is a schematic diagram of the extended vocabulary list data;

FIG. 23 is a graph depicting a ratio accumulated from a higher order accounting for population of actual respective last names in America and frequency in use of the respective last names;

FIG. 24 is a graph depicting a result of an increased accuracy of recognition when the exception dictionary is created in accordance with the recognition degradation contribution degree and an experiment of the speech recognition is carried out;

FIG. 25 is a diagram for describing a procedure for creating a telephone dictionary speech recognition dictionary using the conventional text-to-phonetic symbol converting unit;

FIG. 26 is a diagram for describing a procedure for performing speech recognition using the conventional telephone dictionary speech recognition dictionary;

FIG. 27 is a diagram for describing a procedure for creating a music player speech recognition dictionary using the conventional text-to-phonetic symbol converting unit;

FIG. 28 is a diagram for describing a procedure for performing speech recognition using the conventional music player speech recognition dictionary;

FIG. 29 is a block diagram showing a procedure of the conventional word dictionary size reducing unit; and

FIG. 30A is a diagram showing an example where the phonetic symbol sequence exerting less influence on accuracy of recognition is not identical to the converted phonetic symbol sequence, and FIG. 30B is a diagram showing an example where the phonetic symbol sequence exerting high influence on accuracy of recognition is not identical to the converted phonetic symbol sequence.

### DESCRIPTION OF EMBODIMENTS

Hereinafter, the embodiments of the present invention will now be described with reference to the accompanying drawings. Herein, the same reference numeral denotes the same unit throughout the following description.

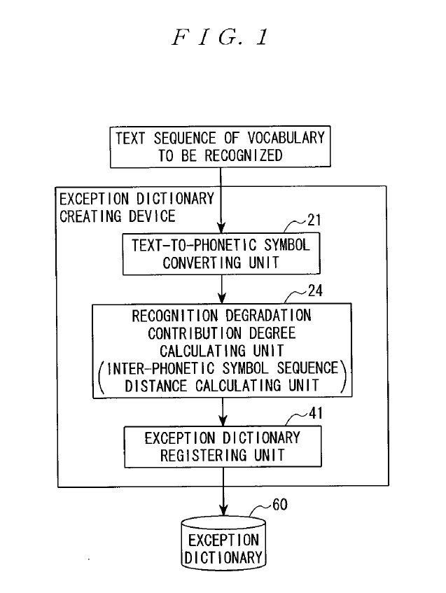

FIG. 1 is a block diagram showing a basic configuration of an exception dictionary creating device according to the present invention. As shown in FIG. 1, the exception dictionary creating device includes: a text-to-phonetic symbol converting unit 21 converting text sequence of vocabulary to be recognized into phonetic symbol sequence; a recognition degradation contribution degree calculating unit (an inter-phonetic symbol sequence distance calculating unit) 24 calculating a recognition degradation contribution degree when a converted phonetic symbol sequence of a text sequence of vocabulary to be recognized is not identical to a correct phonetic symbol sequence of the text sequence of vocabulary to be recognized; and an exception dictionary registering unit 41 selecting the vocabulary to be recognized that is a subject to be registered on the basis of the calculated recognition contribution degree and registering in an exception dictionary 60 of the text sequence of the vocabulary to be recognized that is a subject to be registered and the correct phonetic symbol sequence. In this connection, the recognition degradation contribution degree calculating unit 24 corresponds to “recognition degradation contribution degree unit” or “inter-phonetic symbol sequence distance calculating unit”, recited in claims, respectively.

Detailed description of the exception dictionary creating device according to the present invention having these basic configurations will be made hereinafter in line with the respective embodiments.

### First Embodiment

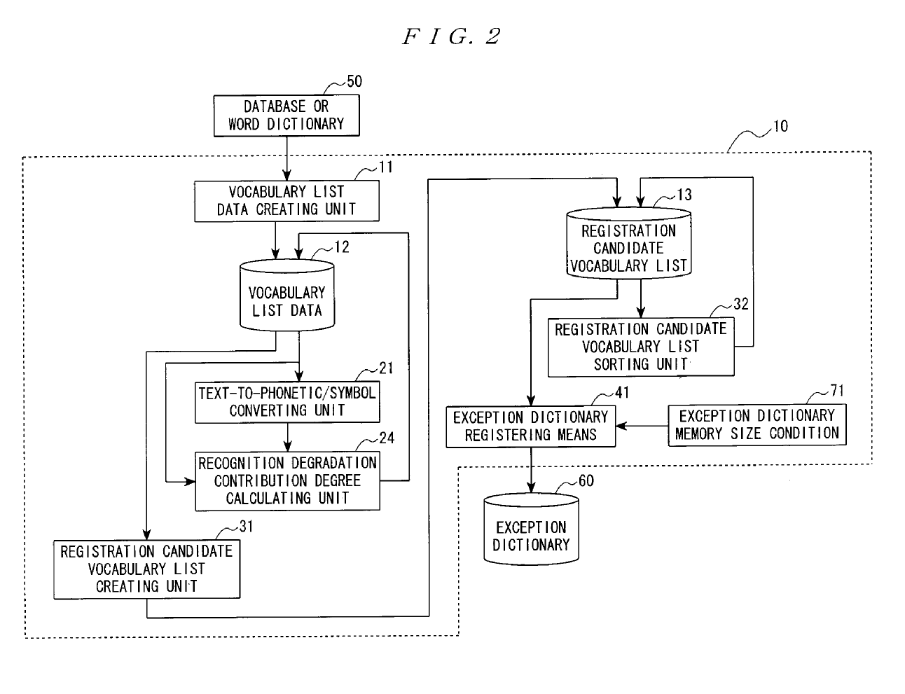

FIG. 2 is a block diagram showing a configuration of the exception dictionary creating device 10 according to the first embodiment of the present invention. The exception dictionary creating device 10 includes a vocabulary list data creating unit 11, a text-to-phonetic symbol converting unit 21, a recognition degradation contribution degree calculating unit 24, a registration candidate vocabulary list creating unit 31, a registration candidate vocabulary list sorting unit 32, and an exception dictionary registering unit 41. These functions are achieved by reading out and executing a program stored in a memory medium such as a memory by a Central Processing Unit (not shown) (CPU) mounted in the exception dictionary creating device 10. Further, vocabulary list data 12, a registering candidate vocabulary list 13, and an exception dictionary memory size condition 71 are data stored in the memory medium such as the memory (not shown) in the exception dictionary creating device 10. Furthermore, a database or a word dictionary 50, and an exception dictionary 60 area database or a data recording area provided in memory medium outside of the exception dictionary creating device 10.

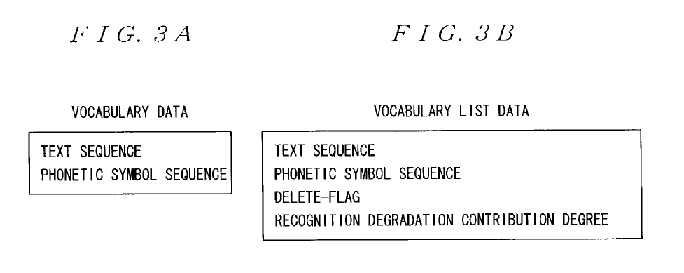

Plural vocabulary data are stored in the database or in the word dictionary 50. In FIG. 3A, an example of data structure of the vocabulary data is given. As shown in FIG. 3A, the vocabulary data is composed of a text sequence of vocabulary and a correct phonetic symbol sequence of the text sequence. Herein, the vocabulary described in the first embodiment encompasses a person's name, a song title, a player, or a name of playing group, a title name of album in which tunes are recorded.

The vocabulary list data creating unit 11 creates vocabulary list data 12 based on the vocabulary data stored in the database or in the word dictionary 50, and registers it in the memory medium such as the memory in the exception dictionary creating device 10.

In FIG. 3B, an example of the data structure of the vocabulary list data 12 is given. The vocabulary list data 12 has the data structure further including a delete-flag and a recognition degradation contribution degree, in addition to the text data sequence and the phonetic symbol sequence contained in the vocabulary data. The delete-flag and the recognition degradation contribution degree are initialized when the vocabulary list data 12 is constructed in the memory medium such as the memory.

The text-to-phonetic symbol converting unit 21 converts the text sequence of the vocabulary to be recognized into the phonetic symbol sequence by using only a rule converting the text sequence into the phonetic symbol sequence, or by using the rule and the existing exception dictionary. Hereunder, a converted result of the text sequence obtained by the text-to-phonetic symbol converting unit 21 is also referred to as “converted phonetic symbol sequence”.

The recognition degradation contribution degree calculating unit 24 calculates a value of the text recognition degradation contribution degree when the phonetic symbol sequence of the vocabulary list data 12 is not identical to the converted phonetic symbol sequence that are the converted result of the text sequence obtained by the text-to-phonetic symbol converting unit 21. Then, the recognition degradation contribution degree calculating unit 24 updates the recognition degradation contribution degree of the vocabulary list data 12 with the calculated value and the delete-flag of the vocabulary list data 12 to false as well.

Hereupon, the recognition degradation contribution degree indicates a degree of exerting an influence on degradation of the speech recognition performance due to the converted phonetic symbol and the correct phonetic symbol sequence. Specifically, the recognition degradation contribution degree is a digitized numeric value representative of a degree of degradation of accuracy of the speech recognition, when the converted phonetic symbol sequence are recognized in the speech recognition dictionary instead of the acquired phonetic symbol sequence, from a degree of the unmatching between the phonetic symbol sequence acquired from the vocabulary list data 12 and the converted phonetic symbol sequence that are the converted result of the phonetic symbol sequence obtained by the text-to-phonetic symbol converting unit 21. In other words, it is an inter-phonetic symbol sequence distance indicating how far a speech uttered in accordance with the phonetic symbol sequence acquired from the vocabulary list data 12 and a speech uttered in accordance with the converted phonetic symbol sequence 22 are distant from each other. The inter-phonetic symbol sequence distance involves: a method for synthesizing speeches by using a speech synthesis device etc. from the phonetic symbol sequence and an inter-phonetic symbol sequence distance is calculated between the synthesized speeches; a method for carrying out speech recognition referring to the speech recognition dictionary in which the phonetic symbol sequence acquired from the vocabulary list data 12 and the converted phonetic symbol sequence are registered and a difference of recognition likelihood between the phonetic symbol sequence is calculated as the inter-phonetic symbol sequence distance; and a method for calculating a difference of the phonetic symbol sequence between the phonetic symbol sequence acquired from the vocabulary list data 12 by Dynamic Programming (DP) matching, for example and the converted phonetic symbol sequence as the inter-phonetic symbol sequence distance. The details of the calculation method will be described later.

Where the phonetic symbol sequence of the vocabulary list data 12 is identical to the converted phonetic symbol sequence that are the converted result of the text sequence by the text-to-phonetic symbol converting unit 21, it is unnecessary to register in the exception dictionary 60. Therefore, the recognition degradation contribution degree calculating unit 24 does not calculate a value of the recognition degradation contribution degree, but updates the delete-flag of the vocabulary list data 12 to true.

The registration candidate vocabulary list creating unit 31 extracts only data of which delete-flag is false from the vocabulary list data 12 as registration candidate vocabulary list data, and creates a registration candidate vocabulary list 13 as a list of the registration candidate vocabulary list data to register it in the memory.

The registration candidate vocabulary list sorting unit 32 sorts the registration candidate vocabulary list data in the registration candidate vocabulary list 13 in order of decreasing recognition degradation contribution degree.

The exception vocabulary registering unit 41 selects the registration candidate vocabulary list data to be registered on the basis of the recognition degradation contribution degree of the respective registration candidate vocabulary list data, among from the plurality of registration candidate vocabulary list data in the registration candidate vocabulary list 13, and registers in the exception dictionary 60 the text sequence of the selected registration candidate vocabulary list data and the phonetic symbol sequence.

More specifically, the exception dictionary registering unit 41 selects the registration candidate vocabulary list data existing in a higher order in the sorting order out of the registration candidate vocabulary list data in the registration candidate vocabulary list 13, that is the registration candidate vocabulary list data with a relatively large recognition degradation contribution degree, and registers in the exception dictionary 60 the text sequence of the selected registration candidate list data and the phonetic symbol sequence. At this time, the maximum number of vocabulary may be registered within the range not exceeding the data limitation capacity memorable in the exception dictionary 60 on the basis of the exception dictionary memory size condition 71 previously set in accordance with the data limitation capacity memorable in the exception dictionary 60. This allows the provision of the exception dictionary 60 affording the optimum speech recognition performance, even though restriction is placed on the data volume memorable in the exception dictionary 60.

When the vocabulary data stored in the database or in the word dictionary 50 used for creating the exception dictionary 60 is composed of vocabularies belonging to a specific category (e.g. a person's name or a place name), a dedicated exception dictionary specialized to that category may be materialized. Moreover, when the text-to-phonetic symbol converting unit 21 already is provided with the exception dictionary, an extended exception dictionary may be realized through a mode in which the exception dictionary 60 newly created with the vocabulary data contained in the database or the word dictionary 50 is added.

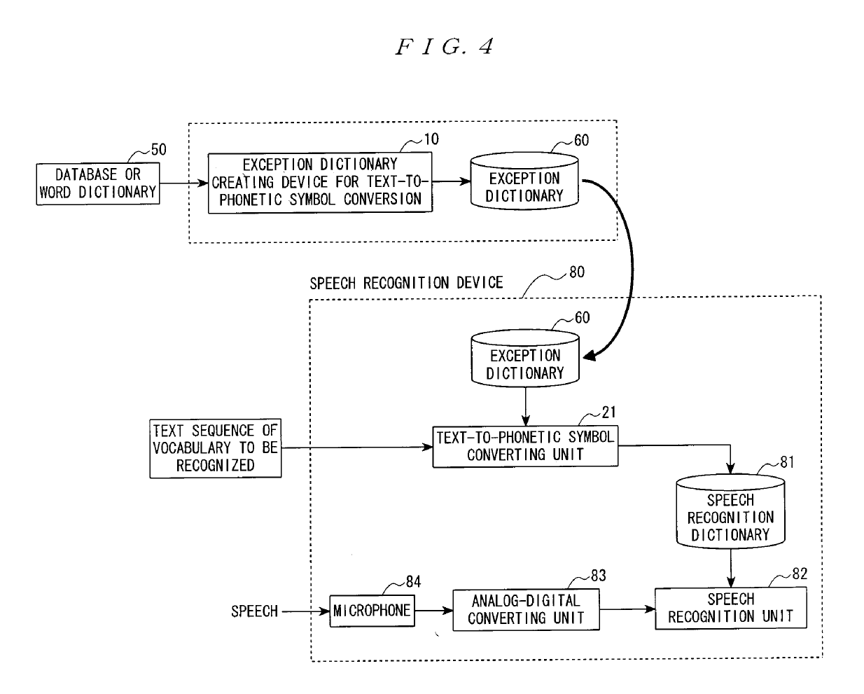

The exception dictionary 60 created by the exception dictionary creating device 10 is used in creating the speech recognition dictionary 81 of the speech recognition device 80 as shown in FIG. 4. The text-to-phonetic symbol converting unit 21 creates the speech recognition dictionary 81 by applying the rule and the exception dictionary 60 to the vocabulary text sequence to be recognized. The speech recognition unit 82 of the speech recognition device 80 recognizes a speech using the speech recognition dictionary 81.

The reduced size of the exception dictionary 60 achieved on the basis of the exception dictionary memory size condition 71 enables utilizing the exception dictionary 60 with the dictionary stored in a cellular phone, even if, e.g. the speech recognition device 80 is a cellular phone with a small memory capacity.

Alternatively, the exception dictionary 60 may be stored in the speech recognition device 80 from the beginning of the production stage thereof, or may be stored by downloading it from a server on the network when the speech recognition device 80 is equipped with communication functions.

Instead, the exception dictionary 60 may be previously stored in a server on the network without storing it in the speech recognition device 80 to use it afterword by the speech recognition device 80 accessing the server.

### (Process Flow)

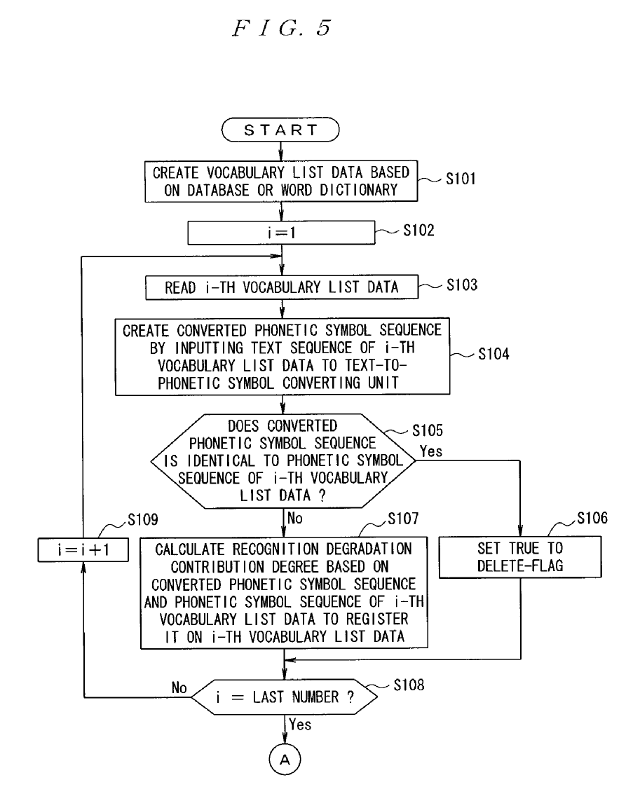

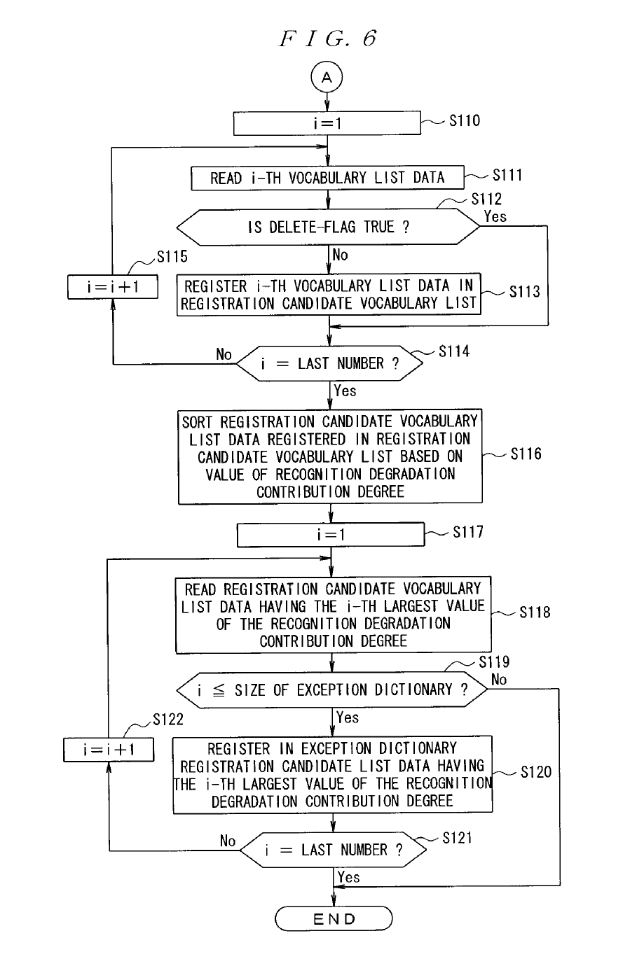

A processing procedure carried out by the exception dictionary creating device 10 will be described with reference to a flow chart shown in FIG. 5 and FIG. 6.

First, the vocabulary list data creating unit 11 of the exception dictionary creating device 10 creates the vocabulary list data 12 on the basis of the database or the word dictionary 50 (step S101 in FIG. 5). Next, 1 is set to a variable i (step S102) and reads in i-th vocabulary list data 12 (step S103).

Second, the exception dictionary creating device 10 inputs the text sequence of the i-th vocabulary list data 12 into the text-to-phonetic symbol converting unit 21, the text-to-phonetic symbol converting unit 21 converts the input text sequence, and creates the converted phonetic symbol sequence (step S104).

Subsequently, the exception dictionary creating device 10 judges whether the created converted phonetic symbol sequence is identical to the phonetic symbol sequence of the i-th vocabulary list data 12 (step S105). If the judgment is made that the converted phonetic symbol sequence is identical to the phonetic symbol sequence of the i-th vocabulary list data 12 (step S105: Yes), then the delete-flag of the i-th vocabulary list data 12 is set to true (step S106).

Otherwise, if the judgment is made that the converted symbol sequence is not identical to the phonetic symbol sequence of the i-th vocabulary list data 12 (step S105: No), then the delete-flag of the i-th vocabulary list data 12 is set to false. Furthermore, the recognition degradation contribution degree calculating unit 24 calculates the recognition degradation contribution degree on the basis of the converted phonetic symbol sequence and the phonetic symbol sequence of the i-th vocabulary list data 12, and registers in the i-th vocabulary list data 12 the calculated recognition degradation contribution degree (step S107).

When the registration of the delete-flag and the recognition degradation contribution degree in the i-th vocabulary list data 12 is terminated in this way, i is incremented (step S109), and the same processing is repeated to the vocabulary list data 12 (steps 103-107). If i reaches the last number (step 108: Yes), and the registration of all the vocabulary list data 12 is terminated, processing proceeds to step S110 in FIG. 6.

At step S110, the exception dictionary creating device 10 sets 1 to i, reads in the i-th vocabulary list data 12 (step S111), and judges whether the delete-flag of the vocabulary list data 12 read in is true (step S112). Only if the delete-flag is not true (step S112: No), the i-th vocabulary list data 12 is registered in the registration candidate list 13 as registration candidate vocabulary list data (step S113).

Judgment is made to determine whether i is the last number (step S114). If i is not the last number (step S114: No), then i is incremented (step S115), and procedures of step S111 to step S114 are repeated to the i-th vocabulary list data 12.

Otherwise, if i is the last number (step S114: Yes), the registration candidate vocabulary list sorting unit 32 sorts the registration candidate vocabulary list data registered in the registration candidate vocabulary list 13 in order of decreasing recognition degradation contribution degree (i.e., in order of decreasing registration priority in the exception dictionary 60) (step S116).

Subsequently, at step S117, 1 is set to i and the exception dictionary registering unit 41 reads in from the registration candidate vocabulary list 13 the registration candidate vocabulary list data having the i-th largest value of the recognition degradation contribution degree (step S118).

The exception dictionary registering unit 41 judges whether the data volume stored in the exception dictionary 60 exceeds the data limitation capacity indicated by the exception dictionary memory size condition 71, when the registration candidate vocabulary list data having the i-th largest value of the recognition degradation contribution degree (step S119).

If the data volume stored in the exception dictionary 60 does not exceed the data limitation capacity indicated by the exception dictionary memory size condition 71 (step S119: Yes), then the registration candidate vocabulary list data having the i-th largest value of the recognition degradation contribution degree (step S120) is registered in the exception dictionary 60. If i is not the last number (step S121: No), i is incremented (step S122), and processing of steps S118 to 5122 are repeated. Otherwise, if i is the last number (step S121: Yes), processing is terminated here.

Meanwhile, if the data volume stored in the exception dictionary 60 exceeds the data limitation capacity (step S119: No), then the processing is terminated without registering the registration candidate vocabulary list data in the exception dictionary 60.

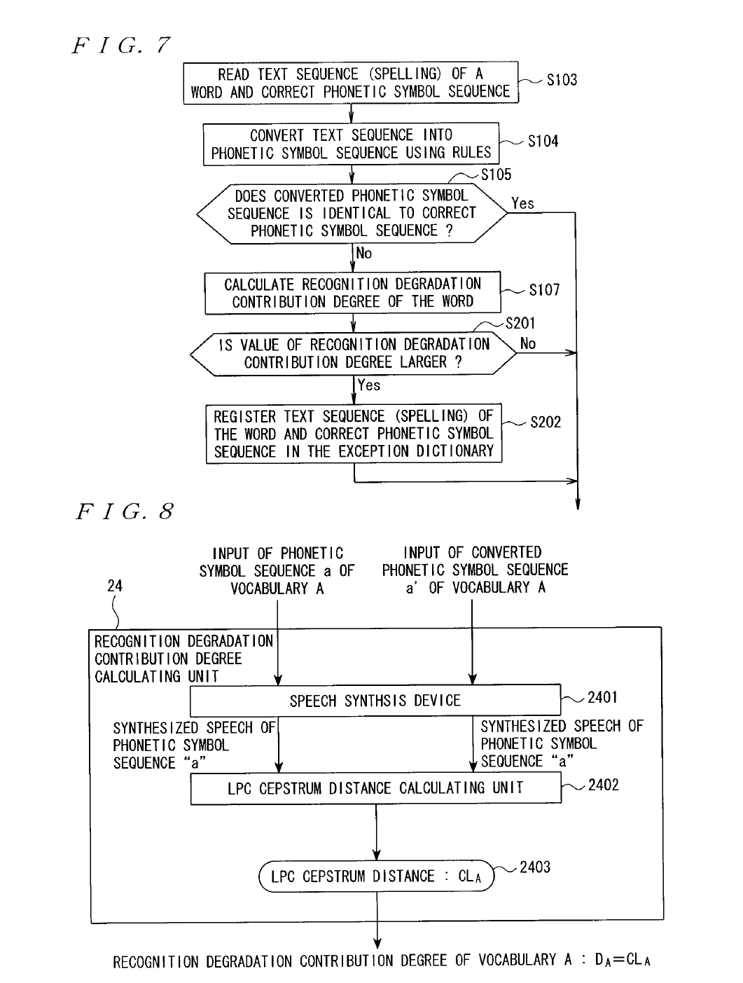

While in the forgoing embodiment, the registration candidate vocabulary list sorting unit 32 sorts the registration candidate vocabulary list data in the registration candidate vocabulary list 13 in order of decreasing recognition degradation contribution degree and the exception dictionary registering unit 41 selects in sorted order the registration candidate vocabulary list data to register it in the exception dictionary 60, it may dispense with a sorting operation by the registration candidate vocabulary list sorting unit 32. Alternatively, for example, as shown at steps S201 and S202 in FIG. 7, the exception dictionary registering unit 41 may register candidate vocabulary list data with the high recognition degradation contribution degree into the exception dictionary 60 by referring directly to the registration candidate vocabulary list 13.

### (Recognition Degradation Contribution Degree)

A detailed description will next be made about various calculating methods of the recognition degradation contribution degree.

### (Recognition Degradation Contribution Degree Utilizing Spectral Distance Measure)

A description is initially made to a recognition degradation contribution degree calculation utilizing the spectral distance measure. The spectral distance measure represents similarity of a short-time spectral of two speeches or a variety of distance measures that are known such as LPC cepstrum, e.g. (“Sound•Acoustic Engineering”, edited by Sadateru HURUI, Kindai Kagakusha, Co., LTD). A description will be made herein about the recognition degradation contribution degree calculating method using the result of LPC cepstrum with reference to FIG. 8.

The recognition degradation contribution degree calculating unit 24 includes a speech synthesis device 2401 synthesizing a synthesized speech in accordance with the phonetic symbol sequence by inputting the phonetic symbol sequence; and a LPC cepstrum distance calculating unit 2402 calculating a LPC cepstrum distance of two synthesized speeches.

When the phonetic symbol sequence “a” of the vocabulary A and the converted phonetic symbol sequence “a′” of the vocabulary A that is a converted result of the text sequence of the vocabulary A by the text-to-phonetic symbol converting unit 21 are input to the recognition degradation contribution degree calculating unit 24, the recognition degradation contribution degree calculating unit 24 inputs the phonetic symbol sequence “a” and the converted phonetic symbol sequence “a′” to the speech synthesis device 2401, respectively, to yield a synthesized speech of the phonetic symbol sequence “a” and a synthesized speech of the converted phonetic symbol sequence “a”. Then, the recognition degradation contribution degree calculating unit 24 inputs the synthesized speech of the phonetic symbol sequence “a” and the synthesized speech of the converted phonetic symbol sequence “a′” to the LPC cepstrum distance calculating unit 2402 to give a LPC cepstrum distance CL_{A} of the synthesized speech of the phonetic symbol sequence “a” and the synthesized speech of the converted phonetic symbol sequence “a′”.

The LPC cepstrum distance CL_{A} is a distance serving as an indicator of judging how far the synthesized speech synthesized from the converted phonetic symbol sequence “a′” is distant from the synthesized speech synthesized from the phonetic symbol sequence “a”. Since the distance CL_{A} is one of the inter-phonetic symbol sequence distances indicating that the larger the CL_{A}, the more distant the phonetic symbol sequence “a” from the phonetic symbol sequence “a” that is a source of the synthesized speech, the recognition degradation contribution degree calculating unit 24 outputs the CL_{A} as a recognition degradation contribution degree DA of the vocabulary A.

The LPC cepstrum distance can be calculated from spectral series of the speech instead of the speech itself. Hence, it is possible to use a unit which outputs the spectral series of speeches in accordance with the phonetic symbol sequence “a” and the converted phonetic symbol sequence “a′” in place of the speech synthesis device 2401 so as to calculate the recognition degradation contribution degree by using the LPC cepstrum distance calculating unit 2402 calculating the LPC cepstrum distance from the spectral series. It is possible to use a distance based on a spectrum calculated by band path filter bank or FFT, as well.

### (Speech Recognition Contribution Degree Utilizing Speech Recognition Likelihood)

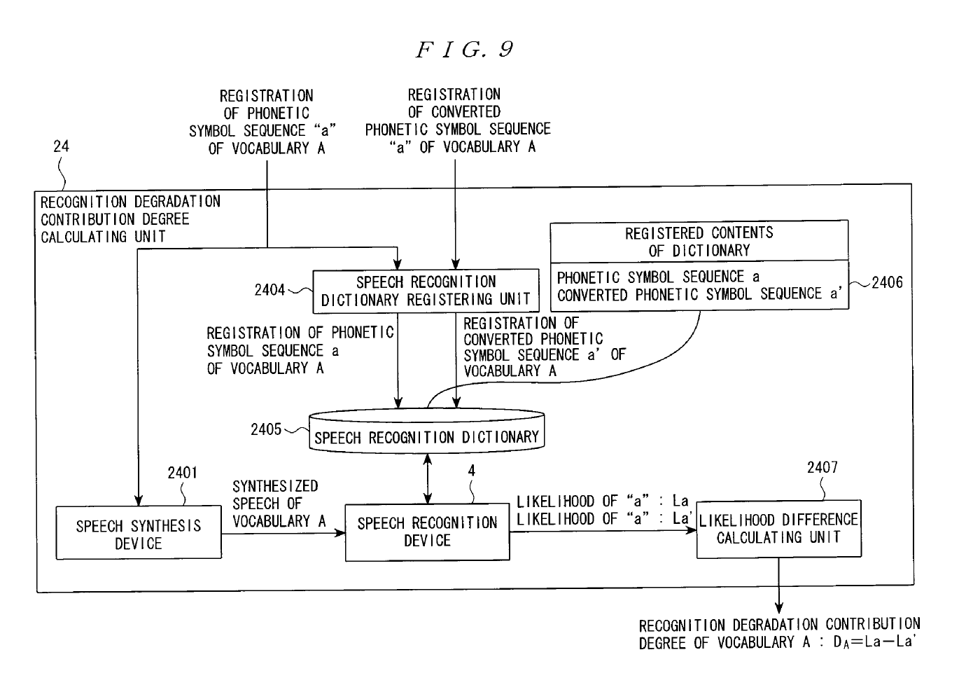

A description will be made to the recognition degradation contribution degree calculating method using the result of the speech recognition likelihood referring to FIG. 9. Here, the speech recognition likelihood is a value stochastically representing a degree of matching of input speech with its vocabulary as to each vocabulary registered in the speech recognition dictionary of the speech recognition device which is called as probability of occurrence or simply as likelihood. Its circumstantial description can be found in “Sound and Acoustic Engineering”, edited by Sadateru HURUI, Kindai Kagaku sha, Co., LTD. The speech recognition device calculates a likelihood of an input speech and respective vocabularies registered in the speech recognition dictionary and gives vocabulary having the highest likelihood, namely vocabulary having the highest degree of matching of the input speech with its vocabulary as the result of the speech recognition.

The recognition degradation contribution degree calculating unit 24 includes a speech synthesis device 2401 synthesizing a synthesized speech in accordance with the phonetic symbol sequence by inputting the phonetic symbol sequence; a speech recognition dictionary registering unit 2404 registering the phonetic symbol sequence in the speech recognition dictionary 2405 in accordance with the input phonetic symbol sequence; a speech recognizing device 4 performing speech recognition using the speech recognition dictionary 2405 and calculating a likelihood of respective vocabularies registered in the speech recognition dictionary 2405; and a likelihood difference calculating unit 2407 calculating the recognition degradation contribution degree from the likelihood calculated by the speech recognition device 4. Actually object to be registered by the speech recognition dictionary registering unit 2404 in the speech recognition dictionary 2405 is not the phonetic symbol sequence themselves but phoneme model data for speech recognition related with the phonetic symbol sequence. Herein, for the sake of brief explanation, a description of the phoneme model data for speech recognition related with the phonetic symbol sequence will be made as phonetic symbol sequence.

When the phonetic symbol sequence “a” of the vocabulary A and the converted phonetic symbol sequence “a′” of the vocabulary A that is the converted result of the text sequence of the vocabulary A converted by the text-to-phonetic symbol converting unit 21 are input to the recognition degradation contribution degree calculating unit 24, the recognition degradation contribution degree calculating unit 24 delivers the phonetic symbol sequence “a” and the converted phonetic symbol sequence “a′” to the speech recognition device 240 and inputs the phonetic symbol sequence “a” to the speech synthesis device 2401. The speech recognition dictionary registering unit 2404 registers the phonetic symbol sequence “a” and the converted phonetic symbol sequence “a′” in the speech recognition dictionary 2405 (see registered contents of the dictionary 2406). The speech synthesis device 2401 synthesizes a synthesized speech of the vocabulary A that is the synthesized speech of the phonetic symbol sequence “a” and inputs the synthesized speech of the vocabulary A to the speech recognition device 4.

The speech recognition device 4 carries out speech recognition of the synthesize of speech of the vocabulary A using the speech recognition dictionary 2405 in which the phonetic symbol sequence “a” and the converted phonetic symbol sequence “a′” are registered, outputs a likelihood La of the phonetic symbol sequence “a” and a likelihood La′ of the converted phonetic symbol sequence “a′”, and delivers them to the likelihood difference calculating unit 2407. The likelihood difference calculating unit 2407 calculates a difference between the likelihood La and the likelihood La′. The likelihood La is a digitized value indicating to what extent the synthesized speech synthesized based on the phonetic symbol sequence “a” matches the phoneme model data sequence corresponding to the phonetic symbol sequence “a”, whereas the likelihood La′ is a digitized value indicating to what extent the synthesized speech matches the phoneme model data sequence corresponding to the converted phonetic symbol sequence “a′”. Accordingly, the difference between the likelihood La and the likelihood La′ is one of the inter-phonetic symbol sequence distances representative of how far the converted phonetic symbol sequence “a′” is distant from the phonetic symbol sequence “a”. Hence, the recognition degradation contribution degree calculating unit 24 outputs the difference between the likelihood La and the likelihood La′ as the recognition degradation contribution degree DA of the vocabulary A.

It is natural to use the synthesized speech synthesized on the basis of the phonetic symbol sequence “a′” for speech recognition in order to find likelihood between the phonetic symbol sequence “a” and the converted phonetic symbol sequence “a′”. But a synthesized speech to be input to the speech recognition device 4 may be taken as a speech synthesized based on the converted phonetic symbol sequence “a′” as what is need is a likelihood difference.

Further, since the likelihood difference of the synthesized speech synthesized based on the phonetic symbol sequence “a” and the likelihood difference of the synthesized speech synthesized based on the converted phonetic symbol a′ are not necessarily matched, an alternative obtained by finding the both likelihood differences and averaged may be adopted as the recognition degradation contribution degree instead thereof.

### (Recognition Degradation Contribution Degree Using DP Matching)

Subsequently, a description will be made to recognition degradation degree calculation using the result of DP matching. This method calculates a difference of the phonetic symbol in the phonetic symbol sequence as the inter-phonetic symbol sequence distance without the synthesized speech.

The DP matching is a technique of determining to what extent two code sequence are similar to each other, which is widely known as the basic technology for pattern recognition and image processing (see e.g., “Outline of DP matching”, edited by Seiichi UCHIDA, Technical Report of the Institutes of Electronics, Information and Communication Engineers, PRMU2006-166 (2006-12)). For instance, when measurement is attempted to determine to what extent a symbol sequence “A′” is similar to a symbol sequence “A”, a method which converts “A” to “A′” with the least number of conversion is estimated by assuming “A” is created from plural combinations among three types of conversions namely, the first conversion where one symbol of the symbol sequence of A′ is substituted for another symbol, which is termed as “substitution error (S: Substitution)”; the second conversion where one symbol originally not existing in the symbol sequence A is inserted, which is termed as “insertion error (I: Insertion)”; and the third conversion where one symbol originally existing in the symbol sequence A is deleted, which is termed as “deletion error (D: Deletion)”. Upon estimation, it is necessary to evaluate which candidate gives the least number of conversions, among the candidates consisting of combination of plural conversions. Each of conversions is considered as a route from “A” to “A′” and evaluated with its route distance, conversion with the shortest rout distance is assumed as conversion pattern of conversion “A′” from “A” with the least number of conversion (referred to as “error pattern”), and considered as the process that “A′” is created from “A”. The shortest route distance applied to evaluation may be deemed as an inter-symbols distance between “A” and “A′”. Such the conversion of “A′” from “A” with the shortest route and the conversion pattern of “A′” from “A” with the shortest route are called as the best matching.

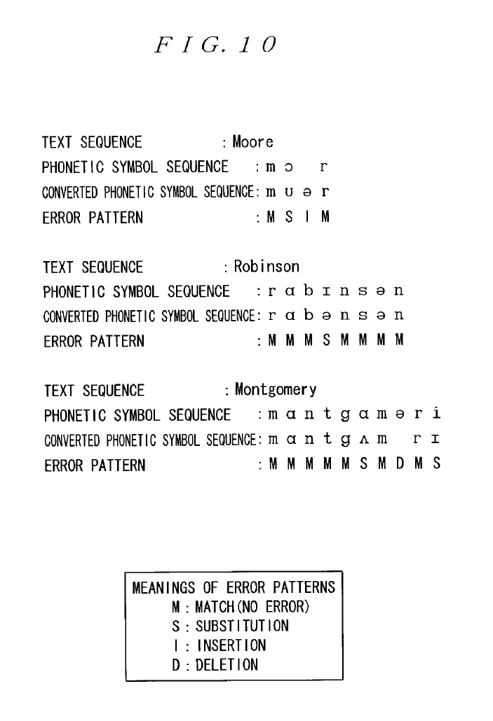

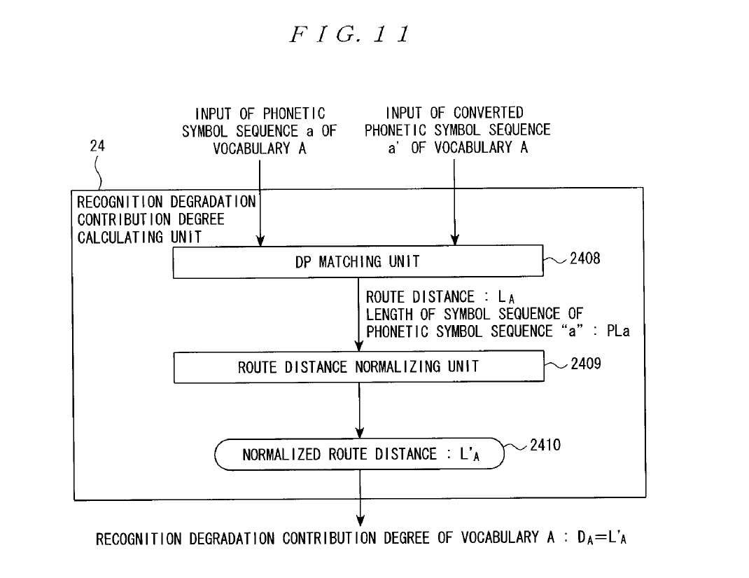

The DP matching may be applied to the phonetic symbol sequence acquired from the vocabulary list data 12 and to the converted phonetic symbol sequence. In FIG. 10, an example of the error pattern output is shown in which the DP matching is applied to the phonetic symbol sequence and the converted phonetic symbol sequence of the last names in America thereto. When the converted phonetic symbol sequence of the text sequence “Moore” is compared with the phonetic symbol sequence of the text sequence “Moore”, a second phonetic symbol from the right of the phonetic symbol sequence is substituted. Then, an insertion occurs between the third and forth phonetic symbol sequence from the right of the phonetic symbol sequence. Further, it is also proved in text sequence “Robinson” that a fourth phonetic symbol from the right of the phonetic symbol sequence is substituted. Besides, it is identified in text sequence “Montgomery” that a sixth phonetic symbol from the right of the phonetic symbol sequence is substituted, an eight phonetic symbol from the right of the phonetic symbol sequence is deleted, and a tenth phonetic symbol from the right of the phonetic symbol sequence is substituted.

When the DP matching is applied to the phonetic symbol sequence acquired from the vocabulary list data 12 and to the converted phonetic symbol sequence to calculate a route distance there between, the route distance has a tendency that the longer phonetic symbol sequence has the larger value of the route distance. Therefore, it is necessary to normalize the route distance with the length of the phonetic symbol sequence to use the route distance as the recognition degradation contribution degree.

As for the recognition degradation contribution degree calculating method utilizing the result of the DP matching will be described referring to FIG. 11. The recognition degradation contribution degree calculating unit 24 includes a DP matching unit 2408 performing DP matching; and a route distance normalizing unit 2409 normalizing the route distance calculated by the DP matching unit 2408 with the length of the phonetic symbol sequence.

When the phonetic symbol sequence “a” of the vocabulary A and the converted phonetic symbol sequence “a′” of the vocabulary A that is the converted result of the text sequence of the vocabulary A by the text-to-phonetic symbol converting unit 21 are input to the recognition degradation contribution degree calculating unit 24, the recognition degradation contribution degree calculating unit 24 delivers the phonetic symbol sequence “a” and the converted phonetic symbol sequence “a” to the DP matching unit 2408.

The DP matching unit 2408 calculates the length of a symbol sequence PLa of the phonetic symbol sequence “a”; find the best matching of the phonetic symbol sequence “a” with the converted phonetic symbol sequence “a”; calculates a route distance L_{A} of the best matching; and delivers the route distance L_{A} and the length of the symbol sequence PLa to the route distance normalizing unit 2409.

The route distance normalizing unit 2409 calculates a normalized route distance LA′ acquired by normalizing the route distance LA with the length of the symbol sequence PLa of the phonetic symbol sequence “a”. The recognition degradation contribution degree calculating unit 24 outputs the normalized route distance LA′ as a recognition degradation contribution degree of the vocabulary A.

### (Recognition Degradation Contribution Degree Calculation Using the Result of the DP Matching and the Weighting Based on Phonetic Symbol Sequence)

The recognition degradation contribution degree calculation using the result of the DP matching has usability of allowing easy calculation of the recognition degradation contribution degree only by using an algorithm of normal DP matching. However, the calculation entails a defect that regardless of whether the details of the substituted phonetic symbol, the details of inserted phonetic symbol, and the details of deleted phonetic symbol, they are dealt with as the same weighting. For example, however, in cases where a vowel is substituted for another vowel having pronunciation proximate thereto and against cases where a vowel is substituted for a consonant having completely different pronunciation, degradation of the accuracy of recognition is strongly caused in the latter cases, so a different influence is exerted on the recognition rata of the speech recognition between the both cases. In consideration of this, weighting is done as follows without equally dealing with the details of all the substitution error, the insertion error, and the deletion error. In case of the substitution error, the weighting is carried out in such a way that the greater the influence on the accuracy of recognition of the speech recognition, the larger the recognition degradation contribution degree for every detail of combination of substitution of the phonetic symbol sequence. Moreover, in case of the insertion error and the deletion error, the weighting is carried out in such a way that the greater the influence on the accuracy of recognition of the speech recognition, the larger the recognition degradation contribution degree for every inserted phonetic symbol sequence and deleted phonetic symbol sequence. Here, comparison is made scrutinizing to the details of the substitution error, the insertion error, and the deletion error of the best matching obtained by the DP matching of the phonetic symbol sequence acquired from the vocabulary list data 12 and the converted phonetic symbol sequence. The recognition degradation contribution degree calculation using the result of the DP matching and the weighting based on the phonetic symbol sequence enables achieving a more accurate recognition degradation contribution degree.

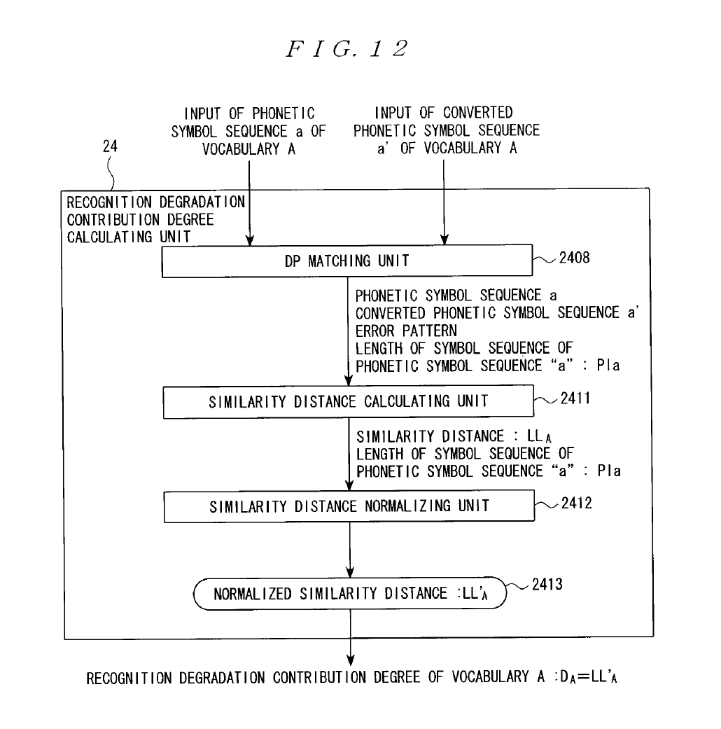

A description of the recognition degradation contribution degree calculating method using the result of the DP matching and the weighting based on the phonetic symbol sequence will be made referring to FIG. 12. The recognition degradation contribution degree calculating unit 24 includes a DP matching unit 2408 performing DP matching; a similarity distance calculating unit 2411 calculating a similarity distance from the best matching determined by the DP matching unit 2408; and a similarity distance normalizing unit 2412 normalizing a similarity distance calculated by the similarity distance calculating unit 2411 with the length of the phonetic symbol sequence.

When the phonetic symbol sequence “a” of the vocabulary A and the converted phonetic symbol sequence “a” of the vocabulary A that is the converted result of the text sequence of vocabulary A by the text-to-phonetic symbol converting unit 21 are input to the recognition degradation contribution degree calculating unit 24, the recognition degradation contribution degree calculating unit 24 delivers the phonetic symbol sequence “a” and the converted phonetic symbol sequence “a′” to the DP matching unit 2408.

The DP matching unit 2408 calculates the length of the phonetic symbol sequence PLa of the phonetic symbol sequence “a”; finds the best matching of the phonetic symbol sequence “a” and the converted phonetic symbol sequence “a′”; and delivers the phonetic symbol sequence “a”, the converted phonetic symbol sequence “a′”, the error pattern, and the length of the symbol sequence PLa of the phonetic symbol sequence “a” to the distance calculating unit 2411.

The similarity distance calculating unit 2411 calculates a similarity distance LL_{A} and delivers the similarity distance LL_{A} and the length of the symbol sequence PLa to the similarity distance normalizing unit 2412. The details of the calculating method of the similarity distance LL_{A} will be described later.

The similarity distance normalizing unit 2412 calculates a normalized similarity distance LL_{A}′ obtained by normalizing the similarity distance LL_{A} with the length of the symbol sequence PLa of the converted phonetic symbol sequence “a”.

The recognition degradation contribution degree calculating unit 24 outputs the normalized similarity distance LL_{A}′ as a recognition degradation contribution degree of the vocabulary A.

### (Similarity Distance)

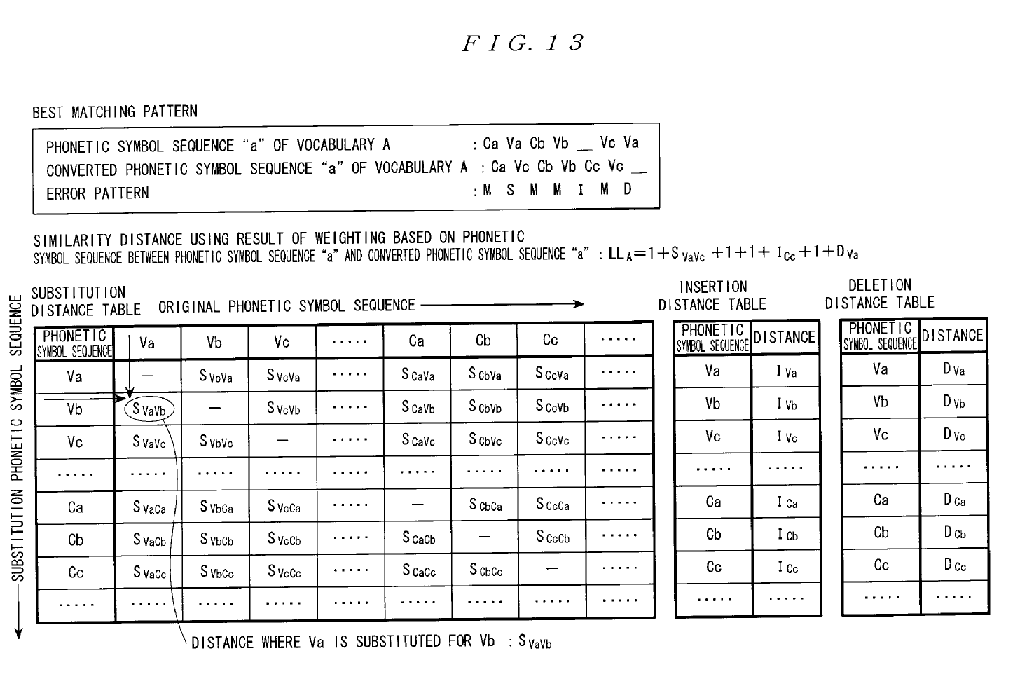

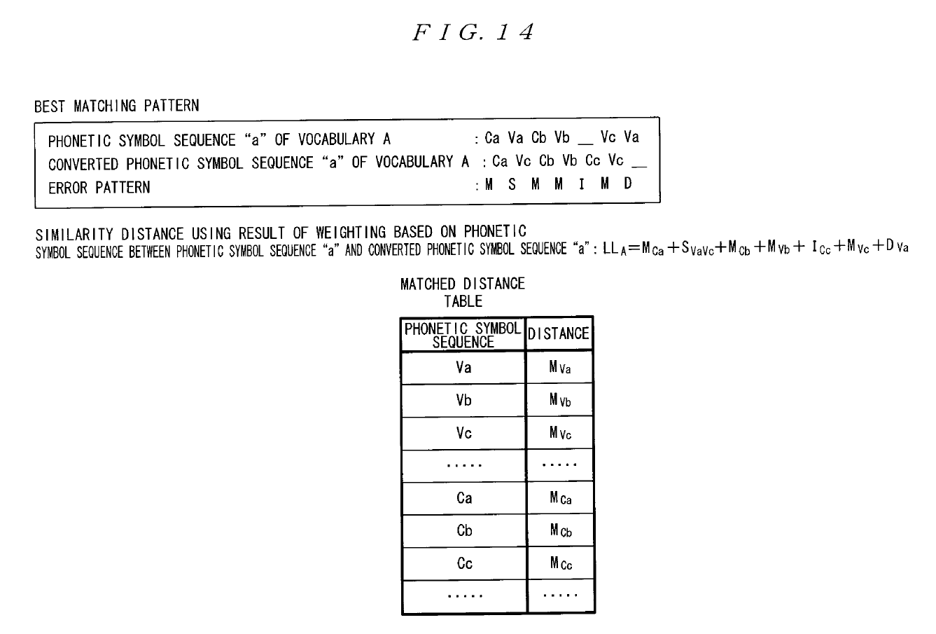

A description of calculating method of the similarity distance LL_{A} by the similarity distance calculating unit 2411 will then be made referring to FIG. 13. FIG. 13 is a diagram showing an example of the best matching, a substitution distance table, an insertion distance table, and a deletion distance table registered in the memory of the exception dictionary creating device 10. Va, Vb, Vc, . . . and Ca, Cb, Cc, . . . , which are listed in the best matching, the substitution distance table, the insertion distance table, and the deletion distance table, denote the phonetic symbol sequence of a vowel and the phonetic symbol sequence of a consonant, respectively. The best matching contains the phonetic symbol sequence “a” of the vocabulary A, the converted phonetic symbol sequence “a′” of the vocabulary A, and the error pattern between the phonetic symbol sequence “a” and the converted phonetic symbol sequence “a′”.

The substitution distance table, the insertion distance table, and the deletion distance table are tables for calculating a distance for every type of errors when the distance is set to 1, if the phonetic symbol sequence is identified by the best matching. More specifically, the substitution table is a table where a distance greater than 1 is defined considering the influence on the accuracy of recognition of the speech recognition for every combination of the phonetic symbol sequence in terms of the substitution error. The insertion distance table is a table where a distance greater than 1 is defined considering the influence on the accuracy of recognition of the speech recognition for every inserted phonetic symbol. The deletion distance table is a table where a distance greater than 1 is defined considering the influence on the accuracy of recognition of the speech recognition for every deleted phonetic symbol. Herein, a line (lateral direction) of the phonetic symbol sequence in the substitution distance table designates the original phonetic symbol sequence and a row (vertical direction) of the phonetic symbol sequence in the substitution distance table designates substituted phonetic symbol sequence. The distance is indicated at a portion on which the row of the original phonetic symbol sequence and the line of the substituted phonetic symbol are intersected when a substitution error occurs. For instance, when a phonetic symbol Va is substituted for a phonetic symbol Vb, a distance S_{VaVb} is given along which the row of the original phonetic symbol Va and a line of the substituted phonetic symbol Vb are intersected is given. An attention should be paid to that the distance S_{VaVb} when the phonetic symbol Va is substituted for the phonetic symbol Vb and the S_{VbVa} when the phonetic symbol Vb is substituted for the phonetic symbol Va are not always the same value. The insertion distance table designates a distance when an insertion of the phonetic symbol occurs per phonetic symbol. For example, when the phonetic symbol Va is inserted, a distance I_{Va} is given. The deletion distance table designates a distance when the phonetic symbol is deleted per phonetic symbol. For instance, when the phonetic symbol Va is inserted, a distance D_{Va} is given. In the phonetic symbol sequence “a” and the converted phonetic symbol sequence “a′” of the best matching of the vocabulary “A”, a distance is 1 as the first phonetic symbol Ca of the phonetic symbol sequence “a” is identical to that of “a”; a distance is S_{VaVc} as the second phonetic symbol Va of the phonetic symbol sequence “a” is substituted for the phonetic symbol Vc of “a′”; a distance is 1 as the third phonetic symbol Cb of the phonetic symbol sequence “a” is identical to that of “a′”; a distance is 1 as the fourth phonetic symbol sequence Vb of the phonetic symbol sequence “a” is identical to that of “a′”; a distance is I_{c}_{_{c}} as Cc is inserted between the fourth phonetic symbol and the fifth phonetic symbol of the phonetic symbol sequence “a”; a distance is 1 as the fifth phonetic symbol Vc of the phonetic symbol sequence “a” is identical to the sixth phonetic symbol Vc of “a′”; and a distance is D_{Va} as the sixth phonetic symbol Va of the phonetic symbol sequence “a” is deleted. As a result, the similarity distance LL_{A} using the result of the weighting based on these phonetic symbol sequence between the phonetic symbol sequence “a”—the converted phonetic symbol sequence “a′” gives a value (1+S_{VaVc}+1+1+I_{c}_{_{c}}+1+D_{Va}) obtained by adding all the distances between these phonetic symbol sequence.

Although the description is made up to here assuming that the distance is set to 1 evenly when the phonetic symbol sequence is identical by the best matching, there can be a critical pronunciation and a relatively low important pronunciation depending on the accuracy of recognition in the speech recognition according to the phonetic symbol sequence even when matching occurs. In this case, when the phonetic symbol sequence is identical to each other, it should determine, for every phonetic symbol, a distance smaller than 1, which develop a tendency that the more important the phonetic symbol sequence to the accuracy of recognition, the smaller the value in view of its importance. Additionally, the provision of a matched distance table as shown in FIG. 14 attains offering an accurate recognition degradation contribution degree, in addition to the substitution distance table, the insertion distance table, and the deletion distance table as shown in FIG. 13. The matched distance table provides a distance M_{Va} when the matched phonetic symbol is Va, for example. A case applying the matched distance table to the phonetic symbol sequence “a” and the converted phonetic symbol sequence “a” is explained as follows. According to the error pattern inter-phonetic symbol sequence “a” and converted phonetic symbol sequence “a′”, the distance is M_{Ca} as the first phonetic symbol Ca of the phonetic symbol sequence “a” is identical to that of “a”; the distance is S_{VaVc} as the second phonetic symbol Va of the phonetic symbol sequence “a” is substituted for a phonetic symbol Vc; the distance is M_{Cb} as the third phonetic symbol Cb of the phonetic symbol sequence “a” is identical to that of “a”; the distance is M_{Vb} as the fourth phonetic symbol Vb of the phonetic symbol sequence “a” is identical to that of “a′”; the distance is I_{Cc} as Cc is inserted between the fourth and the fifth phonetic symbol of the phonetic symbol sequence “a”; the distance is M_{Vc} as the fifth phonetic symbol Vc of the phonetic symbol sequence “a” is identical to sixth phonetic symbol Vc of “a′”; and the distance is D_{Va} as the sixth phonetic symbol Va of the phonetic symbol sequence “a” is deleted. Consequently, the similarity distance LL_{A} using the result of the weighting based on the phonetic symbol sequence between the phonetic symbol sequence “a”—the converted phonetic symbol sequence “a′” is a value (M_{Ca}+S_{VaVe}+M_{Cb}+M_{Vb}+I_{Cc}+M_{Vc}+D_{Va}) obtained by adding all the distances between these phonetic symbol sequence.

### Second Embodiment

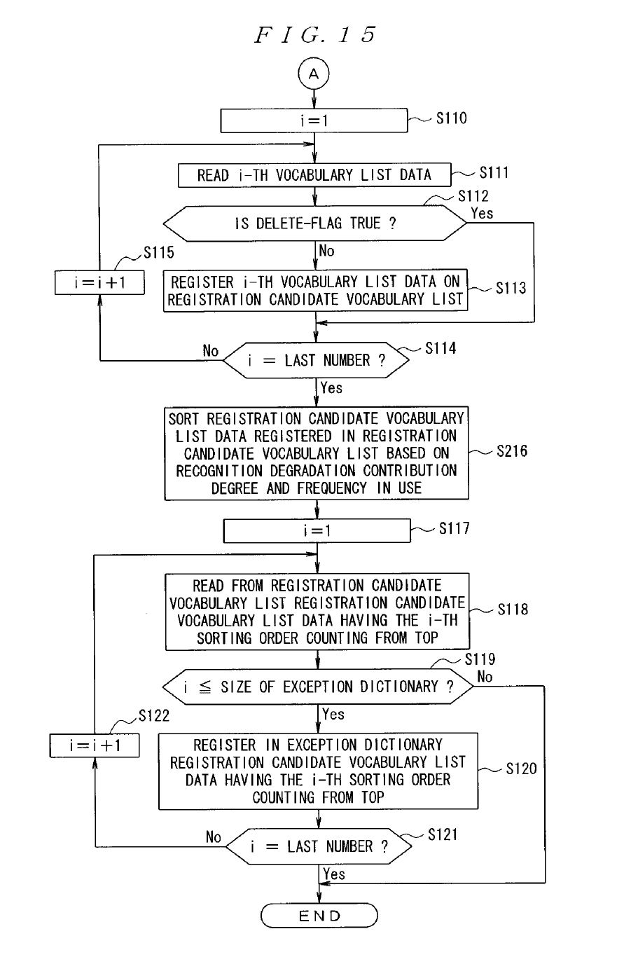

A description of the second embodiment of the present invention will next be made. In the second embodiment, vocabulary data registered in the database or the word dictionary 50 shown in FIG. 2 further contains “frequency in use”. In addition, while in the first embodiment, the registration candidate vocabulary list sorting unit 32 sorts the recognition candidate vocabulary list 13 in order of decreasing the recognition degradation contribution degree (see step S116 of FIG. 6), in the second embodiment, the unit 32 sorts the registration candidate vocabulary list data in further consideration of the frequency in use (see step S216 of FIG. 15 showing a process flow according to the second embodiment). Other configurations and the processing steps thereof are the same as those of the first embodiment.

Hereupon, the terminology “frequency in use” unit a frequency at which respective vocabularies is used in the real world. For instance, the frequency in use of the last name (Last Name: Surname) in some countries can be regarded as being equivalent to the percentage of the population with the last name accounting for the total population, or regarded as the frequency of the appearance of the number of the last name at the time of summing up the total of national census in that country.

Typically, the frequency in use of each vocabulary is different in the real world. Frequently used vocabulary has a high probability of being registered in the speech recognition dictionary, resulting in exerting a strong influence on an accuracy of recognition in a practical speech recognition application. Therefore, when the database or the word dictionary 50 contains the frequency in use, the registration candidate vocabulary list data sorting unit 32 sorts the registration candidate list data in the order in which registration is conducted, taking account of both the recognition degradation contribution degree and the frequency in use.

More specifically, the registration candidate vocabulary list data sorting unit 32 sorts the data based on a predetermined registration order determination condition. The registration order determination condition is composed of three numerical conditions including: a frequency in use difference condition; a recognition degradation contribution degree difference condition; and a preferential frequency in a use difference condition. The frequency in use difference condition, the recognition degradation contribution degree difference condition, and the preferential frequency in use difference condition are respectively varied based on a frequency in use difference condition threshold (DF: DF is given by 0 or a negative number), a recognition degradation contribution degree difference condition threshold (DL: DL is given by 0 or a positive number), and a preferential frequency in use difference condition threshold (PF: PF is given by 0 or a positive number).

Whereas in the first embodiment, the registration candidate vocabulary list data of the registration candidate vocabulary list 13 is sorted in order of decreasing recognition degradation contribution degree by the registration candidate vocabulary list data sorting unit 32, in the second embodiment, the respective registration candidate list data sorted in order of decreasing recognition degradation contribution degree further sorts at three steps from a first step to a third step to be discussed hereinafter.

In the first step, the recognition degradation contribution degree of the respective registration candidate vocabulary list data is checked. When there are two or more registration candidate vocabulary list data with the same recognition degradation contribution degree, a sorting operation is performed in the order of decreasing the frequency in use in these registration candidate vocabulary list data. In this manner, among the registration candidate vocabulary list data with the same recognition degradation contribution degree, vocabulary with the higher frequency in use is preferentially registered in the exception dictionary 60.

In the second step, each of the regeneration candidate vocabulary list data is sorted so as to meet the following conditions, a difference (dF_{n-1, n}=Fₙ₋₁−Fₙ) between frequency in use (Fₙ) of the registration candidate vocabulary list data registered in the n-th of sorting order and the frequency in use (Fₙ₋₁) of the registration candidate vocabulary list data registered in the (n−1)-th of sorting order, which is just before the registration candidate vocabulary list data registered in the n-th sorting order by 1, is equal to or more than the frequency in use difference condition threshold (DF) (dF_{n-1, n}≧DF). Or when dF_{n-1, n} is less than DF (dF_{n-1, n}<DF) a difference (dL_{n-1, n}=Lₙ₋₁−Lₙ) between the recognition degradation contribution degree (Lₙ) of the registration candidate vocabulary list data registered in the (M_{Ca}+S_{VaVe}+M_{cb}+M_{Vb}+I_{Cc}+M_{Vc}+D_{Va}) obtained by adding a n-th and the recognition degradation contribution degree (Lₙ₋₁) of the recognition contributory vocabulary list data of the registration candidate vocabulary registered in the (n−1)−(M_{Ca}+S_{VaVe}+M_{Cb}+M_{Vb}+I_{Cc}+M_{Vc}+D_{Va}) th is equal to or more than the recognition degradation contribution degree difference threshold (DL) (dL_{n-1, n}≧DL). There exist many methods for sorting the respective registration candidate vocabularies list data in this fashion. For example, there is a method as follows. The next operation is executed in turn from the registration candidate vocabulary list data registered in the second order to the registration candidate vocabulary list data in the bottom of the list after processing of the first step is already terminated. That is to say, a difference (dF_{n-1, n}) between the frequency in use of the registration candidate vocabulary list data registered in the n-th order and the frequency in use of the registration candidate vocabulary list data registered in the (n−1)-th order is calculated to compare it with DF. If dF_{n-1, n} is equal to or more than DF (dF_{n-1, n}≧DF), nothing is further executed and a search is made for the registration candidate vocabulary list data registered in the (n+1)-th order. Otherwise, if dF_{n-1, n} is less than DF (dF_{n-1, n}<DF) a difference (dL_{n-1, n}) between the recognition degradation contribution degree of the registration candidate vocabulary list data registered in the n-th order and the recognition degradation contribution degree of the registration candidate vocabulary list data registered in the (n−1)-th order is calculated to compare it with DL. If dL_{n-1, n} is equal to or more than DL (dL_{n-1, n}≧DL), nothing is further executed and a search is made for the registration candidate vocabulary list data registered in the (n+1)-th order. If dL_{n-1, n} is less than DL (dL_{n-1, n}<DL), a search is made for the recognition candidate vocabulary list data registered in the (n+1)-th after swapping the registration candidate vocabulary list data registered in the (n−1)-th order for the registration candidate vocabulary list data registered in the n-th order. For the registration candidate vocabulary list data registered in the (n+1)-th order, the same processing is carried out between the registration candidate vocabulary list data registered in the n-th order and that registered in the (n+1)-th order (i.e., a comparing operation between dF_{n, n+1}=Fₙ−Fₙ₊₁ and DF, and between dL_{n, n+1}=Lₙ−Lₙ₊₁ and DL). When this processing is performed till the registered registration candidate vocabulary list data in the bottom of the list, a first time operation at the second step is terminated. If no swapping operation of the order of the registration candidate vocabulary list data occurs in the first sorting operation at the second step, the second step is terminated here. Otherwise, if at least one swapping operation of the order of the registration candidate vocabulary list data is taken place, the same processing is repeated again for the registration candidate vocabulary list data registered from the second and below the second, as a second sorting operation at the second step. If no swapping operation of the order of the registration candidate vocabulary list data occurs in the second sorting operation at the second step, the second step is terminated here. Otherwise, if at least one swapping operation of the order of the registration candidate vocabulary list data is taken place, the same processing is repeated again for the registration candidate vocabulary list data registered from the second and below the second, as a third sorting operation at the second step. While such processing is being repeated, the second step will be terminated at a certain sorting time where the swapping operation of the order of the registration candidate vocabulary list data occurs no longer.

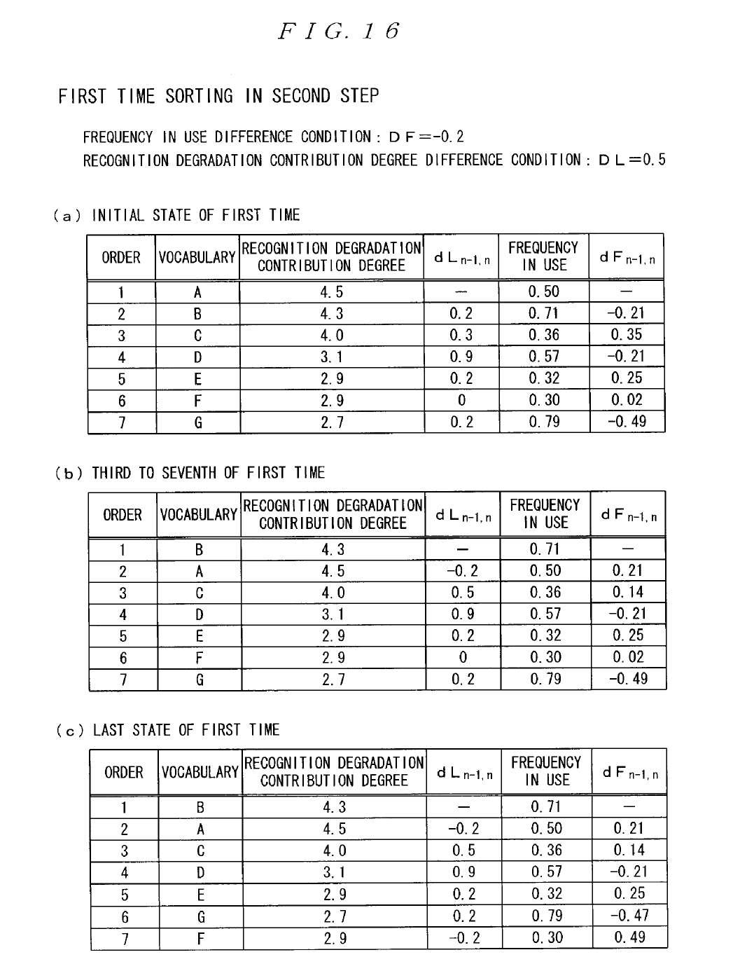

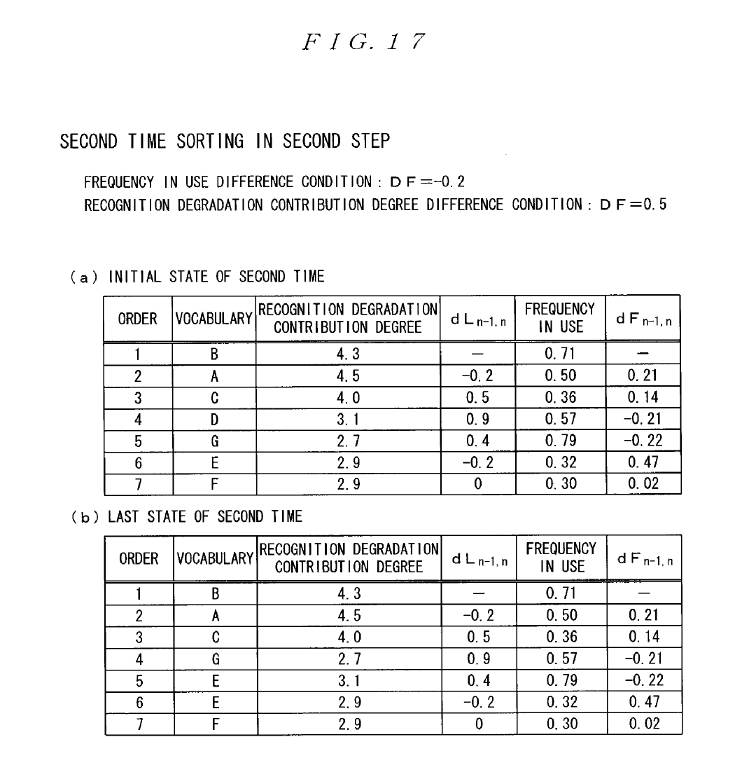

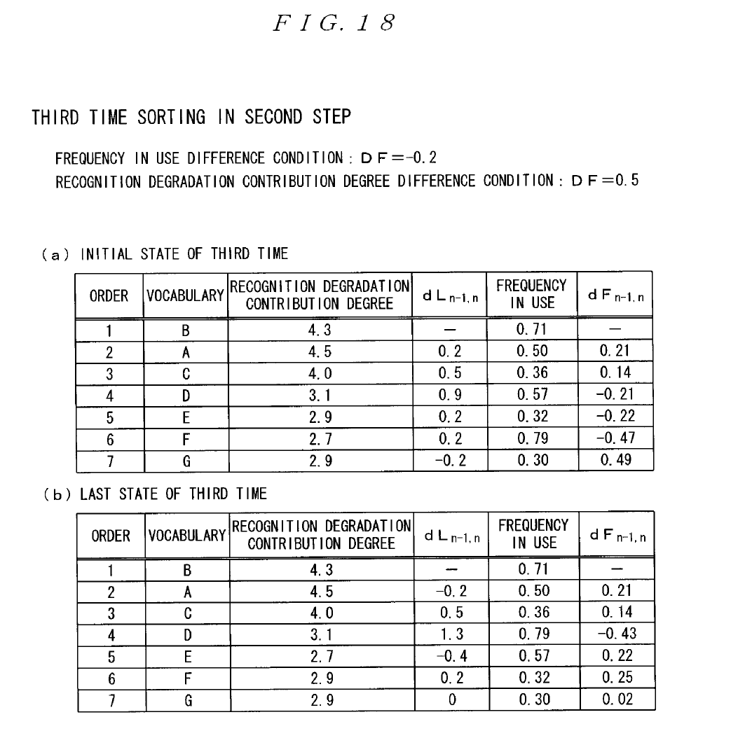

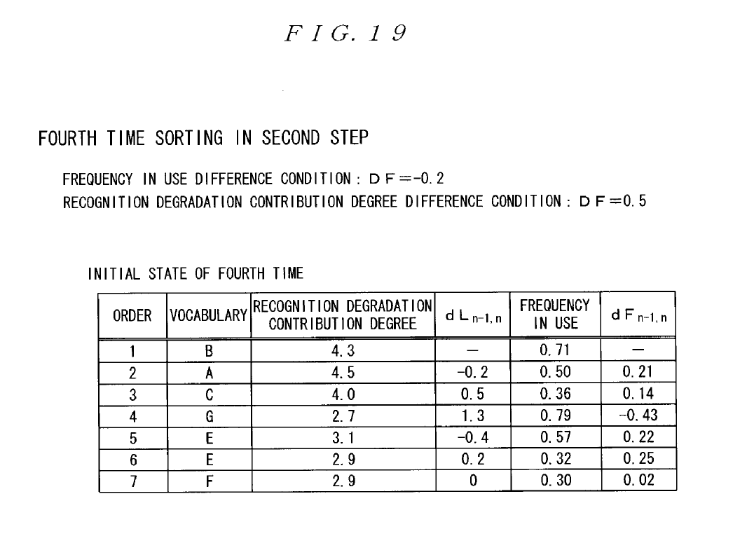

A description of the sorting operation conducted at the above second step will be made in a concrete manner referring to FIG. 16, FIG. 17, FIG. 18, and FIG. 19. Herein, −0.2 is set to DF and 0.5 is set to DL. A table of (a) “initial state of first time” of “first time sorting in second step” of FIG. 16 indicates a state where the first step is terminated. In the table of (a) “initial state of first time”, a relationship of dF_{1,2}<−0.2 is established as dF_{1,2} of the vocabulary B of the second order is −0.21. A sorting operation of swapping the first vocabulary A for the second vocabulary B is executed as dL_{1,2} shows that it is 0.2 and so a relationship of dL_{1,2}<0.5 is established. A state after the sorting operation is a table of (b) “third to seventh of first time” in the (b) “third to seventh of first time”. No sorting operation is taken place as dF_{2,3} of the third vocabulary C is 0.14 and a relationship of dF_{2,3}≧−0.2 is established. A relationship of dF_{3,4}<−0.2 is established as dF_{3,4} of the fourth vocabulary D is −0.21. No sorting operation occurs as dL_{3,4} shows that it is 0.9 and so a relationship of dL_{3,4}≧0.5 is established. Likewise, no sorting operation occurs as dF_{4,5} of the fifth vocabulary E is 0.25 and therefore a relationship of dF_{4,5}≧−0.2 is established. Similarly, no sorting operation is taken place as dF_{5,6} of the sixth vocabulary F is 0.02 and therefore a relationship of dF_{5,6}≧−0.2 is established. On the contrary, a relationship of dF_{6,7}<−0.2 is established as dF_{6,7} of the seventh vocabulary G is −0.49. A sorting operation of swapping the sixth vocabulary F for the seventh vocabulary G occurs as dL_{6,7} shows that it is 0.2 and therefore a relationship of dL_{6,7}<0.5 is established. A state after the sorting operation is a table of (c) “the last state of first time”. Since processing is performed till the last seventh vocabulary, the first sorting operation is terminated here.

A second sorting operation is then performed. The second operation starts from the (a) “initial state of second time” of “second time sorting in second step” of FIG. 17 showing the same state as the (c) “last state of first time” of “first time sorting operation in second step” of FIG. 16. No sorting operation occurs as a relationship of dF_{1,2}≧−0.2 in the second vocabulary A and dF_{1,3}≧−0.2 the third vocabulary C is established, respectively. No sorting operation is taken place as a relationship of dL_{3,4}≧0.5 is established even though a relationship of dF_{3,4}<−0.2 is established in the fourth vocabulary D. Likewise, no sorting operation occurs as a relationship of dF_{4,5}≧−0.2 is established in the fifth vocabulary E. Moreover, a sorting operation of swapping the fifth vocabulary E for the sixth vocabulary G is taken place here as a relationship of dF_{5,6}<−0.2 and dL_{5,6}<0.5 is established in the sixth vocabulary G. A state after the sorting operation is a table of “last state of second time”. No sorting operation is taken place as a relationship of dF_{6,7}≧−0.2 is established in the seventh vocabulary F in the table of “last state of second time”. Similarly, the second sorting operation is terminated here as the sorting operation is performed till the last seventh vocabulary.

A third sorting operation is then performed. The third sorting operation starts from (a) “initial state of third time” of “third time sorting in second step” of FIG. 18 showing the same state as (b) “last state of second time” of “second time sorting in second step” of FIG. 17. No sorting operation occurs as a relationship of dF_{1,2}≧−0.2 in the second vocabulary A and dF_{2,3}≧−0.2 in the third vocabulary C is established. No sorting operation occurs as a relationship of dL_{3,4}≧0.5 is established even though a relationship of dF_{3,4}≧−0.2 is established in the fourth vocabulary D. A sorting operation of swapping the fourth vocabulary D for the fifth vocabulary G occurs as a relationship of dF_{4,5}<−0.2 and dL_{4,5}<0.5 is established in the fifth vocabulary G. A state after the sorting operation is a table of (b) “last state of third time”. No sorting operation occurs as a relationship of dF_{5,6}≧−0.2 in the sixth vocabulary E and dF_{6,7}≧−0.2 in the seventh vocabulary F is established in the table of (b) “last state of third time”. The third sorting operation is terminated here as the sorting operation is performed till the last seventh vocabulary.

A fourth sorting operation is then performed. The fourth sorting operation starts from the “initial state of fourth time” of “fourth time sorting in second step” of FIG. 19 showing the same state as (b) “last state of third time” of “third time sorting in second step” of FIG. 18. No sorting operation is taken place as a relationship of dF_{1,2}≧−0.2 in the second vocabulary A and dF_{2,3}≧−0.2 in the third vocabulary C is established. Likewise, no sorting operation occurs as a relationship of dF_{3,4}≧0.5 is established even though a relationship of dL_{3,4}<−0.2 is established in the fourth vocabulary G. Similarly, no sorting operation occurs as a relationship of dF_{4,5}≧−0.2 in the fifth vocabulary D, dF_{5,6}≧−0.2 in the sixth vocabulary E, and dF_{6,7}≧−0.2 in the seventh vocabulary F is established, respectively. The fourth sorting operation is terminated here as the sorting operation is performed till the last seventh. The second step is also terminated here as no sorting operation occurs during the fourth sorting operation.

The frequency in use difference condition threshold (DF) at the second step is a threshold for judging whether a sorting operation should be carried out based on the recognition degradation contribution degree difference condition when the frequency in use contained in the (n−1)-th registration candidate vocabulary list data is less than the frequency in use contained in the n-th registration candidate vocabulary list data. Herein, If 0 is given as DF, a comparison shall be made based on the recognition degradation contribution degree difference condition threshold (DL) for all the (n−1)-th and the n-th registration candidate vocabulary list data of which frequency in use are reversed. If the data meets the condition, a sorting operation of the registration candidate vocabulary list data shall be carried out. Accordingly, when 0 is given as DF, it follows that whether a sorting operation of swapping the (n−1)-th for the n-th is determined only by DL in the case where the frequency in use of the (n−1)-th vocabulary is less than the frequency in use of the n-th vocabulary.

The recognition degradation contribution degree difference content threshold (DF) at the second step is a value indicating to what extent a reversal of the recognition degradation contribution degree is to be permitted although the reversal of the recognition degradation contribution degree occurs between the (n−1)-th registration candidate vocabulary list data and the n-th registration candidate vocabulary list data if a sorting operation of swapping them is executed, where the frequency in use of the (n−1)-th registration candidate vocabulary list data is less than the frequency in use of the n-th registration candidate vocabulary list data and the frequency in use difference condition is satisfied. Consequently, giving 0 as DL obviates the occurrence of the sorting operation based on the frequency in use, thereby exerting no effect at the second step. On the other hand, taking a large value of DL comes to be sorted in the order in which the vocabulary having the higher frequency in use is preferentially registered in the exception dictionary 60.

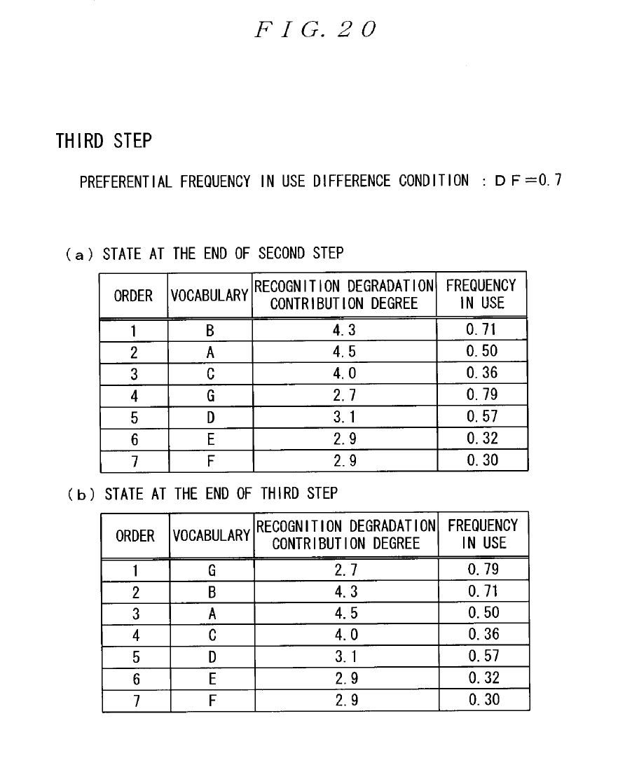

At the third step, as for the registration candidate vocabulary list data with frequency in use higher than the preferential frequency in use difference content threshold (PF), the order of the registration candidate vocabulary list data is sorted in the order of decreasing frequency in use, irrespective of the recognition degradation contribution degree. That is, the registration candidate vocabulary list data with the highest frequency in use is moved to the first order in the registration candidate vocabulary list 13 and the registration candidate vocabulary list data with frequency in use higher than the preferential frequency in use difference condition after the first order is sorted in the order of decreasing frequency in use, irrespective of the recognition degradation contribution degree. A description will be made in a concrete manner referring to FIG. 20. A table of (a) “a state at the end of the second step” of FIG. 20 is in the same state as the end of the second step explained in FIG. 16, FIG. 17, FIG. 18, and FIG. 19, i.e., as the “initial state of the fourth time” of FIG. 19. Here, letting DF be 0.7. The registration candidate vocabulary meeting this condition is the vocabulary B with frequency in use of 0.71 and the vocabulary G with frequency in use of 0.79. Among the vocabularies B and G, the vocabulary G is the first order as it has the highest frequency in use, whereas the vocabulary B is the second order as it has the second highest frequency in use next to the vocabulary G. Other than the above vocabularies, their relative orders will not be changed as they have frequency in use less than PF. Thus, as a result of the sorting operation, it gives the order as illustrated in the table of (b) “the state at the end of the third step”.

In some instances, the second step and/or the third step may be omitted in accordance with a shape of distribution of the frequency in use of the vocabulary. For example, in some cases, when the frequency in use presents a gently-sloping distribution, a satisfactory effect can be accomplished only by the first step. Also, when a limited number of vocabularies placed in the higher frequency in use has enough high frequency in use and the frequency in use of the other vocabularies present gently-sloping distribution of the frequency in use, a satisfactory effect can be attained by executing the third step, after the first step skipping over the second step. Sometimes, when a shape of intermittent distribution of the frequency in use lying in-between the above two types of frequency in use, a sufficient effect may be realized only by the first and the second steps skipping over the third step.

A specific description will be made on an effect exerted when a determination is made to what vocabulary is to be registered in the exception dictionary 60 utilizing the frequency in use of the vocabularies, without limiting to the recognition degradation contributory degree. For easy understanding, a precondition is simplified as follows.

(1) Assume that only the two names (A and B) are failed to acquire their correct phonetic symbol sequence by the text-to-phonetic symbol converting unit 21.

(2) Suppose that the frequency in use of the name A is 10% (an incidence rate of 100 persons per population of 1000 persons), and that the frequency in use of the name B is 0.1% (an incidence rate of 1 person per population of 1000 persons).

(3) When the recognition degradation contribution degree of the name A is a, and the recognition degradation contribution degree of the name B is b, there is a relationship of b>a. Setting an average accuracy of recognition of the name A by the speech recognition unit 82 to 50% and that of the name B to 40% when the name A and the name B are registered in the speech recognition dictionary 81 using the converted phonetic symbol sequence obtained by converting the name A and the name B conducted by the text-to-phonetic symbol converting unit 21, as shown in FIG. 4.

(4) Presume that the average accuracy of recognition of the names, which are registered in the speech recognition dictionary with their correct phonetic symbol sequence, is evenly 90% (when the name A and the name B are registered in the exception dictionary 60 and they are registered in the speech recognition dictionary 81 with their correct phonetic symbol sequence, as shown in FIG. 4, the average accuracy of recognition by the speech recognition unit 82 is also 90%).

(5) Suppose that only one word per name may be registered in the exception dictionary 60 (either the name A or the name B is permitted for registration).

(6) Assume that names registered in the telephone directory in the cellular phone is ten names per one cellular phone user and there are one thousand cellular phone users who register the names registered in the telephone directory in the speech recognition device and use it.

Under such simplified conditions, when the name A or the name B is registered in the exception dictionary 60, calculation is attempted to find an average recognition ratio of the entire telephone directory of one thousand cellular phone users.

Presume that the name B is registered in the exception dictionary 60, the accuracy of recognition of the name B will be 90%, whereas the number with which the name A with the accuracy of recognition of 50% appears in the telephone directory of one thousand cellular phone users in which a name of ten persons per one cellular phone users are registered is estimated to be one hundred times or so. Hence, the average accuracy of recognition of the entire telephone directory is calculated as follows.

((0.9×9000+0.5×1000)/(10×1000))×100=86%

Given the name A is registered in the exception dictionary 60, the accuracy of recognition of the name A is 90%, while the number with which the name B with the accuracy of recognition of 40% appears in the telephone directory of one thousand cellular phone users in which a name of ten persons per one cellular phone users is registered is estimated to be ten times or so. Consequently, the average accuracy of recognition of the entire telephone directory is calculated as follows.

((0.9×9990+0.4×10)/(10×1000))×100=89.95%

When determination of the names registered in the exception dictionary 60 only with the recognition degradation contribution degree is done, the name B is to be registered. However, in some instances, when the frequency in use is subjected to large variations like this, preferential registration of the word has high frequency in used (in this case, the name A) in the exception dictionary 60 can contribute to an augmentation of the accuracy of recognition from the view point of the all users, even though it has a low recognition degradation contribution degree.

### Third Embodiment

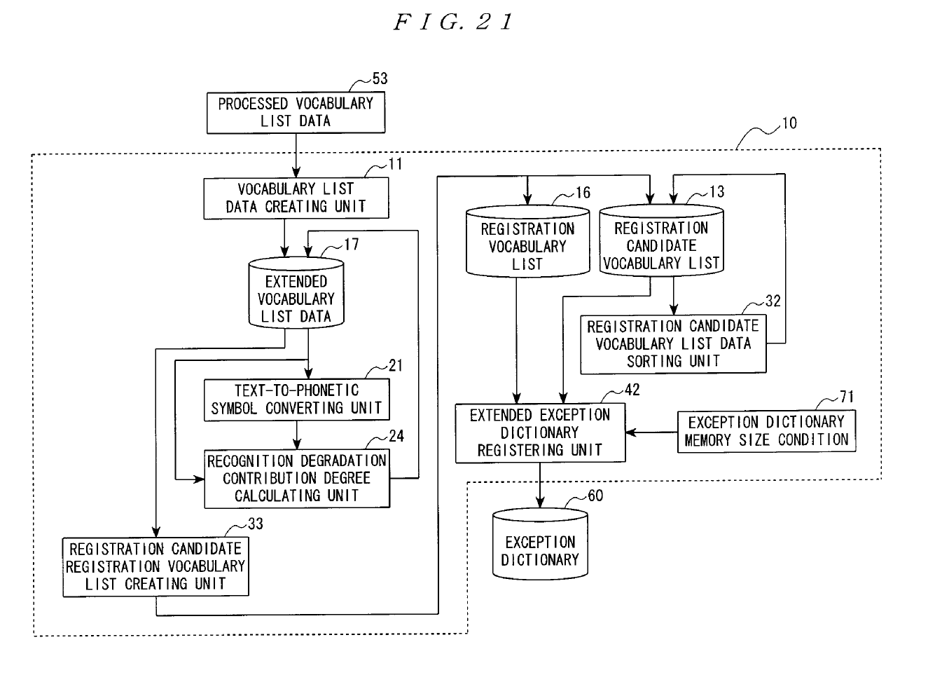

A description of the third embodiment of the present invention will next be made. FIG. 21 is a block diagram showing the structure of the exception dictionary creating device 10 according to the third embodiment. In the first embodiment, vocabulary data such as a person's name and a song title registered in the database or in the word dictionary 50 are taken as an input to the exception dictionary creating device 10. Meanwhile, in the third embodiment, processed vocabulary list data 53 derived from the general vocabulary (corresponding to the “WORD LINKED LIST” disclosed in the Cited Reference 1) to which a delete-flag and a save flag are added through a phase 1 and a phase 2 disclosed in Patent Document 1 is taken as an input to the exception dictionary creating device 10.

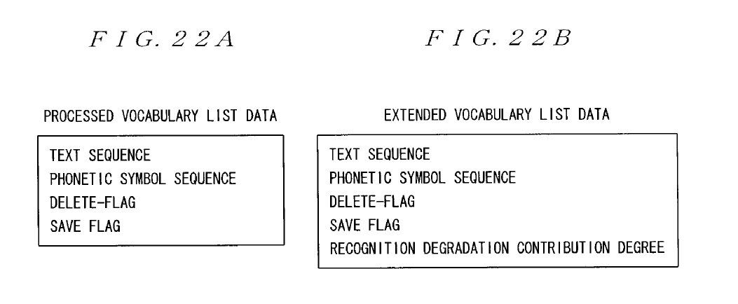

In FIG. 22 A, a data structure of the processed vocabulary list data 53 is shown. As shown in FIG. 22 A, the processed vocabulary list data 53 contains the text sequence, the phonetic symbol sequence, the delete-flag, and the save flag. Additionally, the frequency in use may further be included therein. The flags contained in the processed vocabulary list data 53 let word, which is the root word in the phase 2 disclosed in Patent Document 1, to be a registration candidate (i.e., the save flag is true). On the other hand the flags contained in the processed vocabulary list data 53 let word, of which phonetic symbol sequence created by the root word and a rule is identical to the phonetic symbol sequence registered in the original word dictionary, to be a deletion candidate (i.e., the delete-flag is true).

The exception dictionary creating device 10 creates extended vocabulary list data 17 from the processed vocabulary list data 53 and stores it in a storage medium such as a memory in the exception dictionary creating device 10.

FIG. 22 B shows the data structure of the extended vocabulary list data 17. The extended vocabulary list data 17 has a data structure containing the text data sequence contained in the processed vocabulary list data 53, the phonetic symbol sequence, the delete-flag, and the save flag, and further containing the recognition degradation contribution degree. When processed vocabulary list data 53 contains the frequency in use, the extended vocabulary list data 17 further contains the frequency in use. Moreover, the text sequence, the phonetic symbol sequence and the logical values of the delete-flag and save flag in the extended vocabulary list data 17 are copied from the processed vocabulary list data 53. The recognition degradation contribution degree is initialized when the extended vocabulary list data 17 is built in the storage medium such as the memory.

The text-to-phonetic symbol converting unit 21 converts the i-th text sequence (i=1 to the number of the last data) input from the extended vocabulary list data 17 to create the converted phonetic symbol sequence.

When the recognition degradation contribution degree calculating unit 24 receives i-th converted phonetic symbol sequence from the text-to-phonetic symbol converting unit 21, the unit 24 checks the delete-flag and the save flag held in the i-th extended vocabulary list data 17. As a result of the check up, if the delete-flag is true, or if the delete-flag is false and the save flag is true (i.e., the word to be used as the root of a word), no processing is carried out. Otherwise, if the delete-flag is false and the save flag is false, the recognition degradation contribution degree is calculated from the converted phonetic symbol sequence and from the phonetic symbol sequence acquired from the extended vocabulary list data 17, and registers the calculated recognition degradation contribution degree in i-th extended vocabulary list data 17.

A registration candidate and registration vocabulary list creating unit 33 deletes the vocabulary data of which delete-flag is true and the save flag is false in the extended vocabulary list data 17 after processing by the text-to-phonetic symbol converting unit 21 and the recognition degradation contribution degree calculating unit 24 is completed for all the extended vocabulary list data 17. The residual vocabulary data in the extended vocabulary data 17 are classified into two categories with the vocabulary of which save flag is true (i.e., vocabulary used to as the root word) as a registration vocabulary, and with vocabulary of which delete-flag is false and the save flag is false as a registration candidate vocabulary. The registration candidate and registration vocabulary list creating unit 33 stores the text sequence and the phonetic symbol sequence of the respective registration vocabularies in the storage medium such as the memory as registration vocabulary list 16. Furthermore, the registration candidate and the registration vocabulary list creating unit 33 stores the text sequence, the phonetic symbol sequence, and the recognition degradation contribution degree (inclusive of the frequency in use in case of containing the frequency in use) of the respective recognition candidate vocabularies in the memory medium such as the memory, as the recognition candidate vocabulary list 13.

The registration candidate vocabulary list sorting unit 32 sorts the registration candidate vocabulary of the registration candidate vocabulary list 13 in the order of decreasing the registration priority in the same way as mentioned in the first embodiment or the second embodiment.

Firstly, an extended exception dictionary registering unit 42 registers the text sequence and the phonetic symbol sequence of the respective registration vocabularies of the registration vocabulary list 16 in the exception dictionary 60. Subsequently, the unit 42 registers the text sequence of respective vocabularies and the phonetic symbol sequence of respective registration candidate vocabularies of the registration candidate vocabulary list 13 in the exception dictionary 60 in the order of decreasing the registration priority, within the range not exceeding the data limitation capacity indicated by the exception dictionary memory size condition 71. This provides the exception dictionary 60 offering the optimum speech recognition performance under a prescribed limitation placed on the size of the dictionary even for general words.

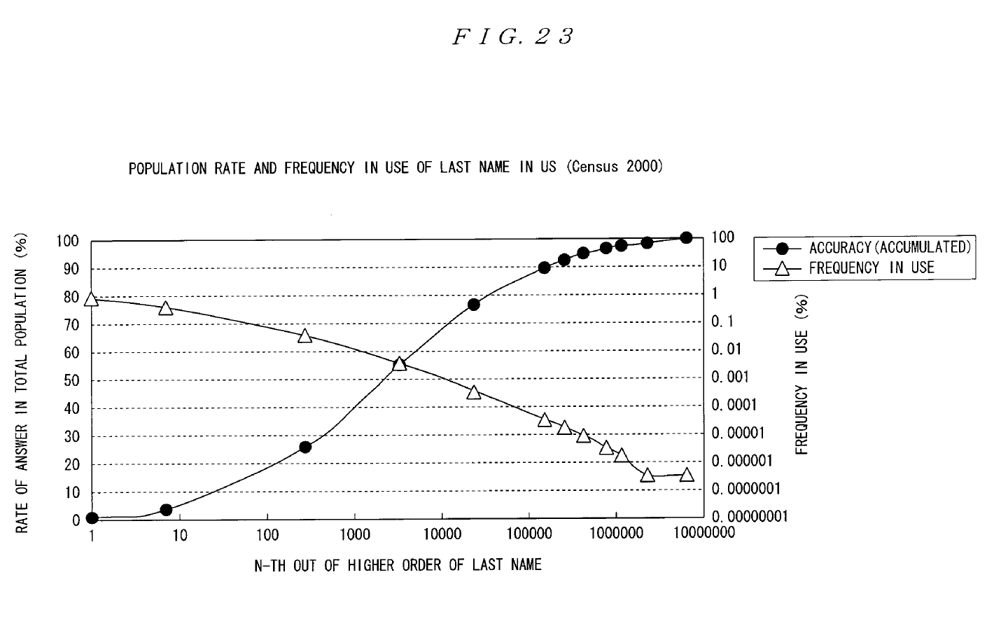

FIG. 23 is a graph in which an accumulated accounting for population rate of actual each last name in the United States of America that is accumulated from the last name with the higher population rate, and a graph illustrating the frequency in use of each of the last name. The total number of samples is 269,762,087 and the total number of the last name is 6,248,415. These numbers are extracted from the answers of the Census 2000 conducted in the United States of America (National Census of 2000).

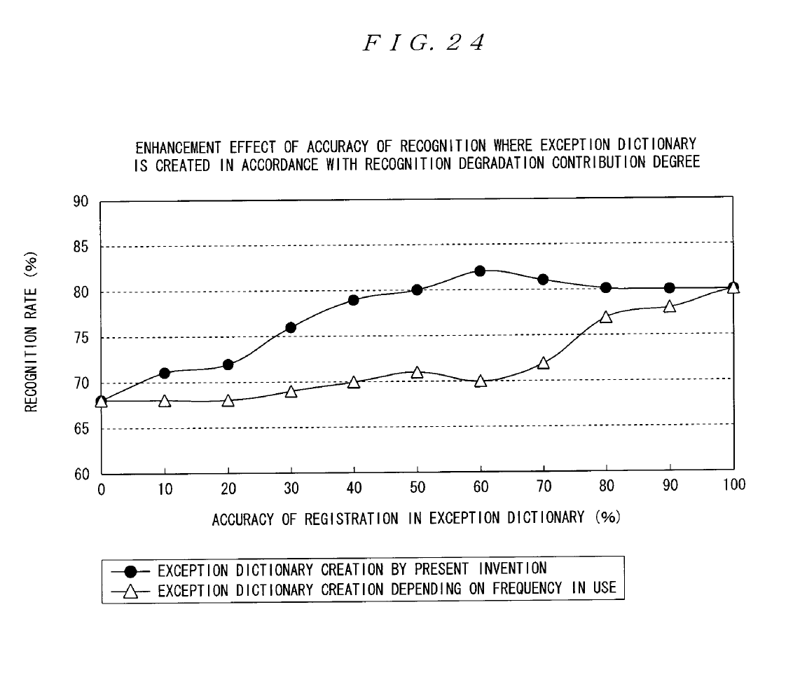

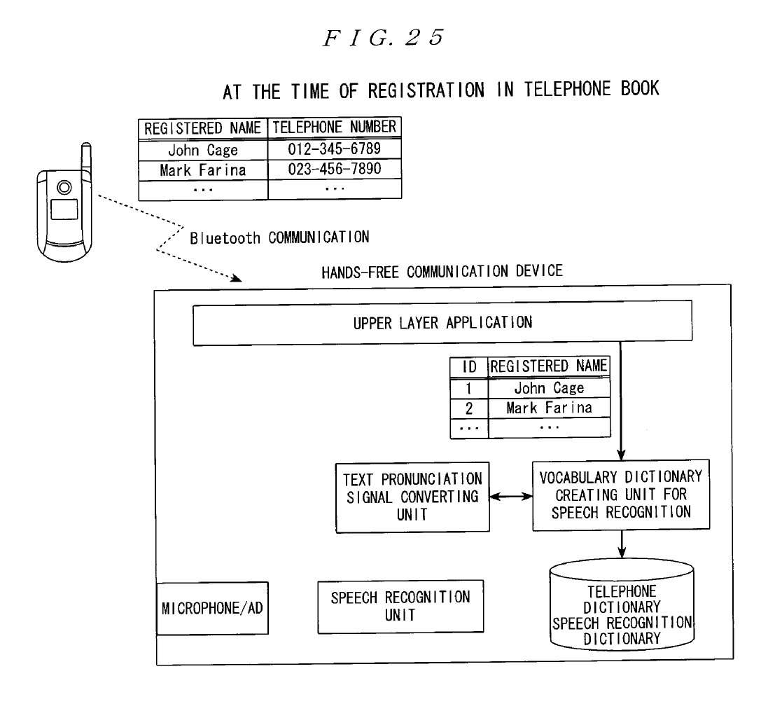

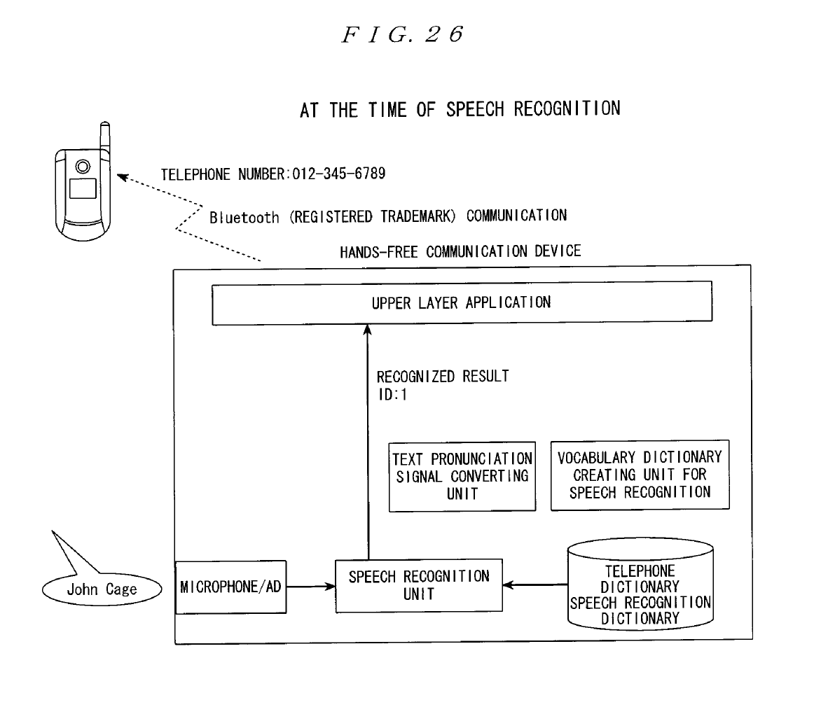

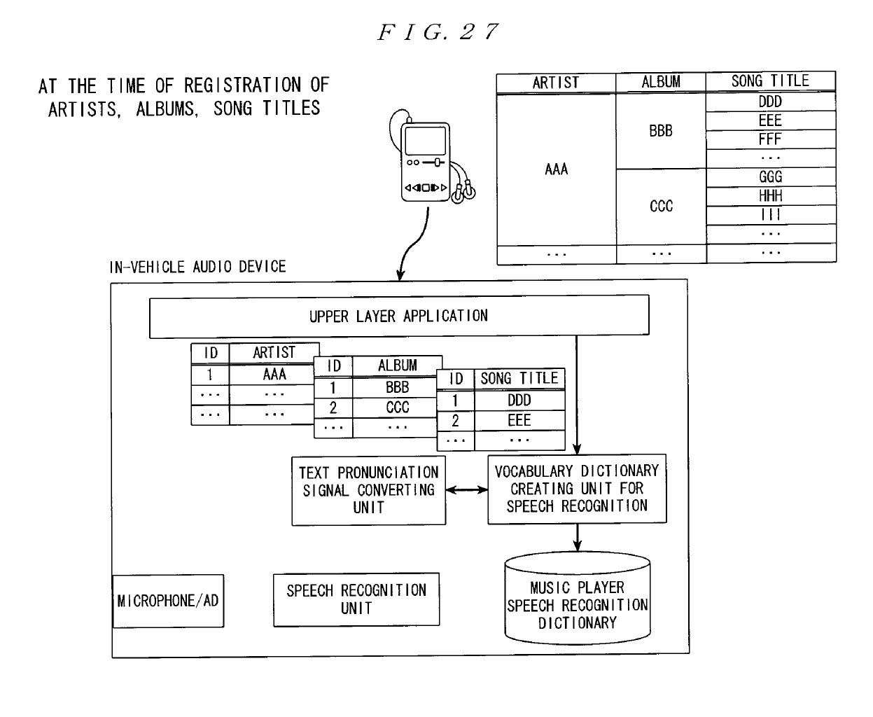

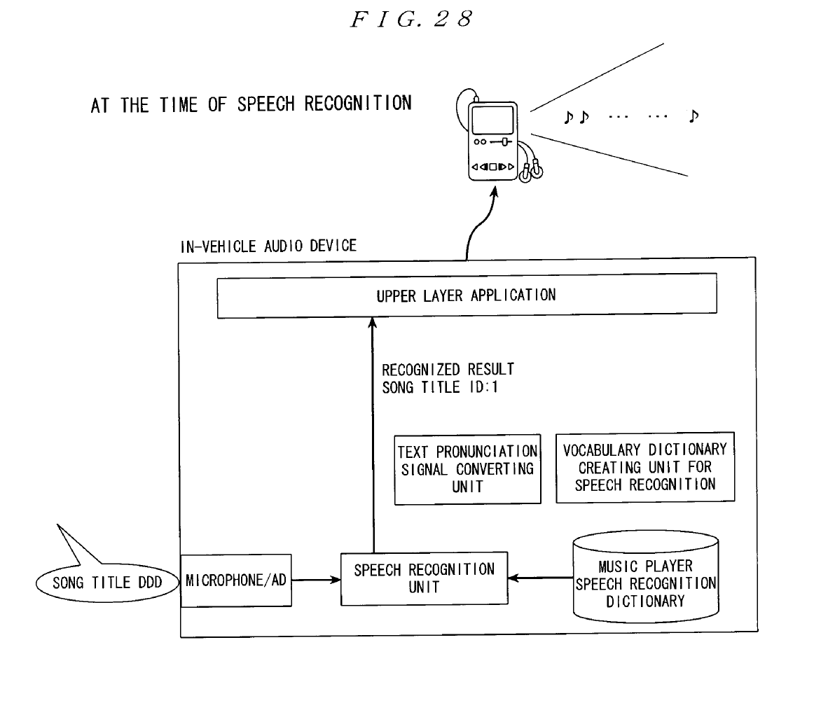

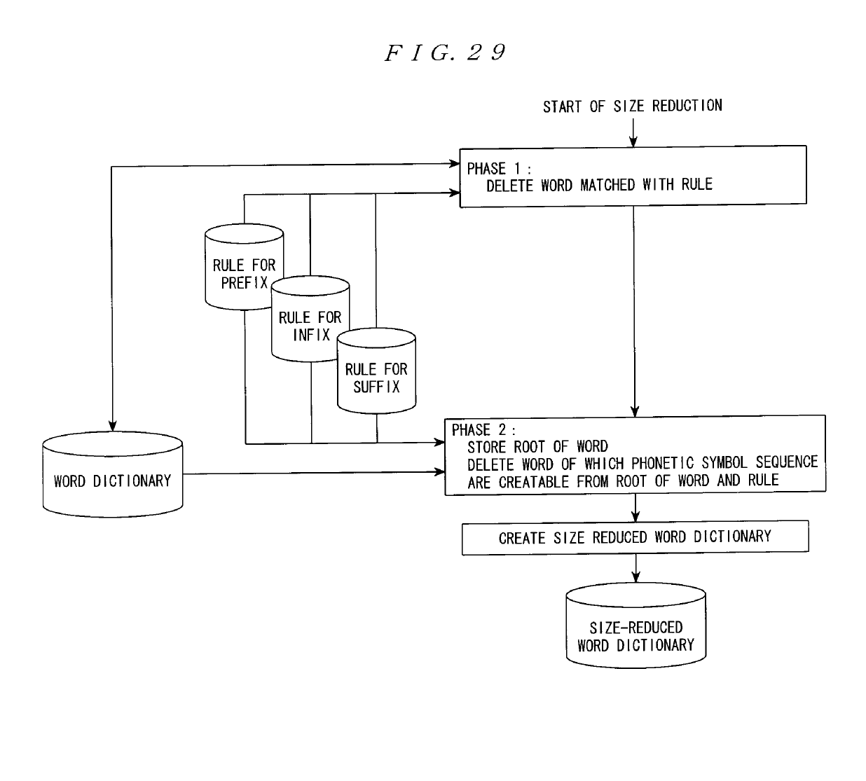

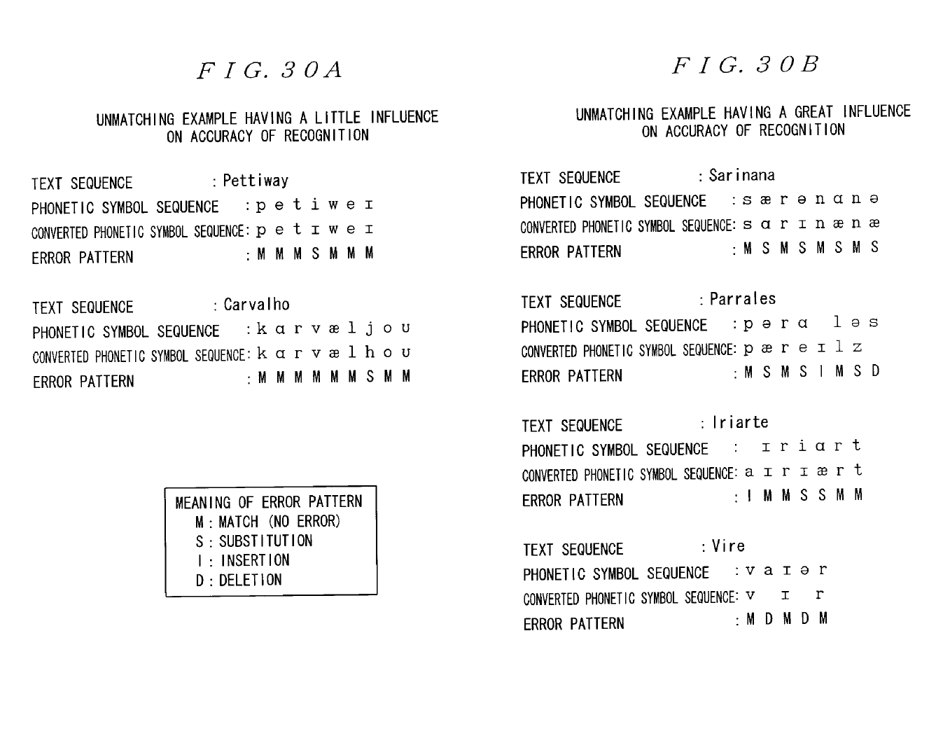

FIG. 24 is a graph showing a result of enhanced accuracy of recognition where the exception dictionary 60 is created in accordance with the recognition degradation contribution degree and then a speech recognition experiment is conducted. The experiment is made for the vocabulary database containing the ten thousands last names which are found in the United States of America. The database contains the frequency in use of the last name in the United States of America (i.e., respective ratios of population of each last name accounting for the total population). Out of the two graphs, the graph of “exception dictionary creation by present invention” shows the accuracy of recognition where the recognition degradation contribution degree is calculated using the result of a LPC cepstrum distance for the vocabulary database containing ten thousands last names which are found in the United States of America, and a speech recognition experiment is made with the exception dictionary 60 which is created according to the recognition degradation contribution degree. Meanwhile, the graph of “exception dictionary creation depending on frequency in use” shows the accuracy of recognition when the exception dictionary 60 is created on the basis only of the frequency in use.

More specifically, the graph of “exception dictionary creation by present invention” denotes a change in the accuracy of recognition where the size of the exception dictionary 60 is gradually increased by 10% (when the registration ratio of the exception dictionary is changed) in such a way as will be shown hereinafter. There are last names of which phonetic symbol sequence converted by the existing text-to-phonetic symbol converting device is not identical to the phonetic symbol sequence registered in the vocabulary database containing the ten thousands last names which are found in the United States of America. In the first case, 10% of such last names are registered in the exception dictionary 60 in accordance with the proportion of the recognition degradation contribution degree. In the second case, 20% of such last names are registered in the exception dictionary 60 in accordance with the proportion of the recognition degradation contribution degree. In the third case, 30% of such last names are registered in the exception dictionary 60 in accordance with the proportion of the recognition degradation contribution degree, and so on. On the other hand, the graph of “exception dictionary creation depending on frequency in use” indicates a change in the accuracy of recognition where the size of the exception dictionary is increased by 10% in such a way that the registration ratio is gradually increased as will be shown hereinafter. In the first case, 10% of such last names are registered in the exception dictionary in order of decreasing frequency in use. In the second case, 20% of such last names are registered in the exception dictionary in order of decreasing frequency in use. In the third case, 30% of such last names are registered in the exception dictionary in order of decreasing frequency in use, and so on.

The accuracy of recognition is a result of the speech recognition for the whole vocabulary containing one hundred last names which is randomly selected from the vocabulary database containing the ten thousands last names which are found in the United States of America, and the whole vocabulary containing one hundred last names is registered in the speech recognition dictionary. The speech of vocabulary containing one hundred last names used for measurement of the accuracy of recognition is a synthesized speech and input to a speech synthesis device is the phonetic symbol sequence registered in the database.

As can be seen from the graphs, when the speech recognition dictionary in the case where the registration ratio in the exception dictionary is 0% (when the conversion of phonetic symbol sequence is conducted only using the rule without using the exception dictionary 60) is used, the accuracy of recognition is 68% in this experiment. In contrast, when the speech recognition dictionary in the case where registration ratio in the exception dictionary is 100% is used, the accuracy of recognition is improved to 80%. From the above, it is shown that an enhanced effect of the accuracy of recognition is verified when the exception dictionary is adopted. Hereupon, the accuracy of recognition with the exception dictionary 60 according to the present invention reaches 80% when the registration ratio in the exception dictionary 60 is 50%. It may be understood from this that when the exception dictionary 60 is created in accordance with the recognition degradation contribution degree, the accuracy of recognition is maintained even if the vocabulary to be registered in the exception dictionary 60 are reduced to half (i.e., the memory size of the exception dictionary 60 is reduced about to half). Contrarily, when the exception dictionary is created depending on the frequency in use, the accuracy of recognition does not reach to 80% till the registration ratio in the exception dictionary reaches 100%. Furthermore, at every point ranging from the registration ratio of 10% to 90%, the accuracy of recognition for the case using the exception dictionary according to the present invention exceeds the accuracy of recognition in the case where the exception dictionary is used based on the frequency in use information. From the above experimental results, effectiveness of the creating method of the exception dictionary 60 according to the present invention is clearly verified.

In this connection, it should be appreciated that the present invention may of course be applied to other languages than English without being always limited to vocabularies in English.

### REFERENCE SIGNS LIST

10 Exception dictionary creating device
11 Vocabulary list data creating unit
12 Vocabulary list data
13 Registration candidate vocabulary list
16 Registration vocabulary list
17 Extended vocabulary list data
21 Text-to-phonetic symbol converting unit
22 Converted phonetic symbol sequence
24 Recognition degradation contribution degree calculating unit
31 Registration candidate vocabulary list creating unit
32 Registration candidate vocabulary list sorting unit
33 Registration candidate and registration vocabulary list creating unit
41 Exception dictionary registering unit
42 Extended exception dictionary registering unit
50 Database or word dictionary
53 Processed vocabulary list data
60 Exception dictionary
71 Exception dictionary memory size condition

1. An exception dictionary creating device for creating an exception dictionary used for a converter converting a text sequence of a vocabulary to be recognized into a phonetic symbol sequence on the basis of a rule of converting the text sequence of the vocabulary into the phonetic symbol sequence and the exception dictionary storing the text sequence of an exception word not to be converted by the rule and a correct phonetic symbol sequence of the text sequence in correlation with each other, the exception dictionary creating device comprising:
a text-to-phonetic symbol converting unit for converting the text sequence of the vocabulary to be recognized into the phonetic symbol sequence;
a recognition degradation contribution degree calculating unit for calculating a recognition degradation contribution degree that is a degree of exerting an influence on degradation of a speech recognition performance due to a difference between a converted phonetic symbol sequence which is a conversion result of the text-to-phonetic symbol converting unit and the correct phonetic symbol sequence of the text sequence of the vocabulary to be recognized, when the converted phonetic symbol sequence is not identical to the correct phonetic symbol sequence; and
an exception dictionary registering unit for selecting the vocabulary to be recognized that is a subject to be registered from a plurality of the vocabularies to be recognized on the basis of the recognition degradation contribution degree for each of the plurality of the vocabularies to be recognized by the recognition degradation contribution degree calculating unit, and for registering in the exception dictionary the text sequence of the vocabulary to be recognized that is a selected subject to be registered and the correct phonetic symbol sequence of the text sequence.

2. The exception dictionary creating device according to claim 1, further comprising an exception dictionary memory size condition storing unit for storing a limitation of data capacity memorable in the exception dictionary,
wherein the exception dictionary registering unit carries out the registration so that a data amount to be registered in the exception dictionary does not exceed the limitation of the data capacity.

3. The exception dictionary creating device according to claim 1, wherein the exception dictionary registering unit selects the vocabulary to be recognized that is the subject to be registered also on the basis of a frequency in use of the plurality of the vocabularies to be recognized.

4. The exception dictionary creating device according to claim 3, the exception dictionary registering unit preferentially selects the vocabulary to be recognized with the frequency in use greater than a predetermined threshold as the vocabulary to be recognized that is the subject to be registered irrespective of the recognition degradation contribution degree.

5. The exception dictionary creating device according to claim 1, wherein the recognition degradation contribution degree calculating unit calculates a spectral distance measure between the converted phonetic symbol sequence and the correct phonetic symbol sequence as the recognition degradation contribution degree.

6. The exception dictionary creating device according to claim 1, wherein the recognition degradation contribution degree calculating unit calculates a difference between a speech recognition likelihood that is a recognized result of a speech based on the converted phonetic symbol sequence and a speech recognition likelihood that is a recognized result of the speech based on the correct phonetic symbol sequence as the recognition degradation contribution degree.

7. The exception dictionary creating device according to claim 1, wherein the recognition degradation contribution degree calculating unit calculates a route distance between the converted phonetic symbol sequence and the correct phonetic symbol sequence by best matching, and calculates a normalized route distance by normalizing the calculated route distance with a length of the correct phonetic symbol sequence, as the recognition degradation contribution degree.

8. The exception dictionary creating device according to claim 7, wherein the recognition degradation contribution degree calculating unit calculates a similarity distance as the route distance by adding weighting on the basis of a relationship of the corresponding phonetic symbol sequence between the converted phonetic symbol sequence and the correct phonetic symbol sequence, and calculates the normalized similarity distance by normalizing the calculated similarity distance with the length of the correct phonetic symbol sequence, as the recognition degradation contribution degree.

9. A speech recognition device comprising:
a speech recognition dictionary creating unit for converting a text sequence of a vocabulary to be recognized into a phonetic symbol sequence using the exception dictionary created by the exception dictionary creating device according to claim 1, and for creating a speech recognition dictionary based on the converted result; and
a speech recognizing unit for performing speech recognition using the speech recognition dictionary created by the speech recognition dictionary creating unit.

10. An exception dictionary creating method for creating an exception dictionary used for in a converter converting a text sequence of vocabulary to be recognized into a phonetic symbol sequence on the basis of a rule of converting the text sequence of the vocabulary into the phonetic symbol sequence and the exception dictionary in which the text sequence of an exception words not to be converted by the rule and the correct phonetic symbol sequence of the text sequence is stored in correlation with each other, the exception dictionary creating method comprising:
a text-to-phonetic symbol converting step of converting the text sequence of the vocabulary to be recognized into the phonetic symbol sequence;
a recognition degradation contribution degree calculating step of calculating a recognition degradation contribution degree that is a degree of exerting an influence on degradation of speech recognition performance due to a difference between a converted phonetic symbol sequence which is a conversion result of the text-to-phonetic symbol converting step and a correct phonetic symbol sequence of the text sequence of the vocabulary to be recognized, when the converted phonetic symbol sequence is not identical to the correct phonetic symbol sequence; and
an exception dictionary registering step of selecting the vocabulary to be recognized that is a subject to be registered from the plurality of vocabulary to be recognized on the basis of the recognition degradation contribution degree calculated for each of the plurality vocabulary to be recognized in the recognition degradation contribution degree calculating step, and registering in the exception dictionary the text sequence of the vocabulary to be recognized that is a selected subject to be registered and the correct phonetic symbol sequence of the text sequence.

11. A speech recognition method comprising:
a speech recognition dictionary creating step for converting a text sequence of the vocabulary to be recognized into a phonetic symbol sequence using the exception dictionary created by the exception dictionary creating method according to claim 10, and for creating a speech recognition dictionary based on the converted result; and
a speech recognizing step for performing speech recognition using the speech recognition dictionary created by the speech recognition dictionary creating step.

12. An exception dictionary creating program executed by a computer for creating an exception dictionary used for a converter converting a text sequence of a vocabulary to be recognized into a phonetic symbol sequence on the basis of a rule of converting the text sequence of the vocabulary into the phonetic symbol sequence and the exception dictionary storing the text sequence of an exception word not to be converted by the rule and a correct phonetic symbol sequence of the text sequence in correlation with each other, the exception dictionary creating program comprising:
a text-to-phonetic symbol converting unit for converting the text sequence of the vocabulary to be recognized into the phonetic symbol sequence;
a recognition degradation contribution degree calculating unit for calculating a recognition degradation contribution degree that is a degree of exerting an influence on degradation of a speech recognition performance due to a difference between a converted phonetic symbol sequence which is a conversion result of the text-to-phonetic symbol converting step and a correct phonetic symbol sequence of the text sequence of the vocabulary to be recognized, when the converted phonetic symbol sequence is not identical to the correct phonetic symbol sequence; and
an exception dictionary registering unit for selecting the vocabulary to be recognized that is a subject to be registered from a plurality of the vocabularies to be recognized on the basis of the recognition degradation contribution degree for each of the plurality of the vocabularies to be recognized by the recognition degradation contribution degree calculating unit, and for registering in the exception dictionary the text sequence of the vocabulary to be recognized that is a selected subject to be registered and the correct phonetic symbol sequence of the text sequence.

13. An exception dictionary creating device for creating an exception dictionary used for a converter converting a text sequence of a vocabulary to be recognized into a phonetic symbol sequence on the basis of a rule of converting the text sequence of the vocabulary into the phonetic symbol sequence and the exception dictionary storing the text sequence of an exception word not to be converted by the rule and a correct phonetic symbol sequence of the text sequence in correlation with each other, the exception dictionary creating device comprising:
a text-to-phonetic symbol converting unit for converting the text sequence of the vocabulary to be recognized into the phonetic symbol sequence;
an inter-phonetic symbol sequence distance calculating unit for calculating an inter-phonetic distance that is distance between a speech based on a converted phonetic symbol sequence which is a converted result of the text sequence of the vocabulary to be recognized by the text-to-phonetic symbol converting unit and a speech based on the correct phonetic symbol sequence of the text sequence of vocabulary to be recognized, when the converted phonetic symbol sequence is not identical to the correct phonetic symbol sequence; and
an exception dictionary registering unit for selecting the vocabulary to be recognized that is a subject to be registered from a plurality of the vocabularies to be recognized on the basis of the inter-phonetic symbol sequence distance for each of the plurality of the vocabularies to be recognized by the inter-phonetic symbol sequence distance calculating unit, and for registering in the exception dictionary the text sequence of the vocabulary to be recognized that is a selected subject to be registered and the correct phonetic symbol sequence of the text sequence.

14. An exception dictionary creating method for creating an exception dictionary use for in a converter converting a text sequence of a vocabulary to be recognized into a phonetic symbol sequence on the basis of a rule of converting the text sequence of the vocabulary into the phonetic symbol sequence and the exception dictionary in which the text sequence of an exception word not to be converted by the rule and a correct phonetic symbol sequence of the text sequence are stored in correlation with each other, the exception dictionary creating method comprising:
a text-to-phonetic symbol converting step of converting the text sequence of the vocabulary to be recognized into the phonetic symbol sequence;
an inter-phonetic symbol sequence distance calculating step of calculating an inter-phonetic distance that is distance between a speech based on a converted phonetic symbol sequence which is a converted result of the text sequence of the vocabulary to be recognized by the text-to-phonetic symbol converting unit and a speech based on the correct phonetic symbol sequence of the text sequence of vocabulary to be recognized, when the converted phonetic symbol sequence is not identical to the correct phonetic symbol sequence; and
an exception dictionary registering step of selecting the vocabulary to be recognized that is a subject to be registered from a plurality of the vocabulary to be recognized on the basis of the inter-phonetic symbol sequence distance calculated for each of the plurality vocabulary to be recognized in the inter-phonetic symbol sequence distance calculating step, and registering in the exception dictionary the text sequence of the vocabulary to be recognized that is a selected subject to be registered and the correct phonetic symbol sequence of the text sequence.

15. An exception dictionary creating program executed by a computer for creating an exception dictionary used for a converter converting a text sequence of a vocabulary to be recognized into a phonetic symbol sequence on the basis of a rule of converting the text sequence of the vocabulary into the phonetic symbol sequence and the exception dictionary storing the text sequence of an exception word not to be converted by the rule and a correct phonetic symbol sequence of the text sequence in correlation with each other, the exception dictionary creating program comprising:
a text-to-phonetic symbol converting unit for converting the text sequence of the vocabulary to be recognized into the phonetic symbol sequence;
an inter-phonetic symbol sequence distance calculating unit for calculating an inter-phonetic distance between a speech based on the converted phonetic symbol sequence which is a converted result of the text sequence of the vocabulary to be recognized by the text-to-phonetic symbol converting unit and a speech based on the correct phonetic symbol sequence of the text sequence of vocabulary to be recognized, when the converted phonetic symbol sequence is not identical to the correct phonetic symbol sequence of the text sequence; and
an exception dictionary registering unit for selecting the vocabulary to be recognized that is a subject to be registered from a plurality of the vocabularies to be recognized on the basis of the inter-phonetic symbol sequence distance for each of the plurality of the vocabularies to be recognized by the inter-phonetic symbol sequence distance calculating unit, and for registering in the exception dictionary the text sequence of the vocabulary to be recognized that is a selected subject to be registered and the correct phonetic symbol sequence of the text sequence.

16. A vocabulary-to be recognized registering device comprising:
a vocabulary, to be recognized, having a text sequence of the vocabulary and a correct phonetic symbol sequence of the text sequence;
a text-to-phonetic symbol converting unit for converting the text sequence of the vocabulary to be recognized into the phonetic symbol sequence by a predetermined rule;
a converted phonetic symbol converted by the text-to-phonetic symbol converting unit;
an inter-phonetic symbol sequence distance calculating unit for calculating a distance between a speech based on the converted phonetic symbol sequence and a speech based on the correct phonetic symbol sequence; and
a vocabulary to be recognized registering unit for registering the vocabulary to be recognized on the basis of the distance between the phonetic symbol sequence calculated by the inter-phonetic symbol sequence distance calculating unit.

17. A vocabulary-to be recognized registering device comprising:
a text-to-phonetic symbol converting unit for converting a text sequence of a vocabulary to be recognized into a phonetic symbol sequence by a predetermined rule;
an inter-phonetic symbol sequence distance calculating unit for calculating a distance between a speech based on the phonetic symbol sequence converted by the text-to-phonetic symbol converting unit and a speech based on the correct phonetic symbol sequence of the vocabulary to be recognized; and
a vocabulary-to be recognized registering unit for registering the vocabulary to be recognized on the basis of the distance between the phonetic symbol sequence calculated by the inter-phonetic symbol sequence distance calculating unit.

18. A speech recognition device comprising:
an exception dictionary containing vocabulary to be recognized registered by the vocabulary-to be recognized registering unit of the vocabulary-to be recognized registering unit according to claim 16;
a speech recognition dictionary creating unit for converting the text sequence of the vocabulary to be recognized into the phonetic symbol sequence using the exception dictionary, and creating a speech recognition dictionary based on the converted result; and
a speech recognition unit for performing speech recognition using the speech recognition dictionary created by the speech recognition dictionary creating unit.
